(19) United States
(12) Patent Application Publication
(10) Pub. No.: US 2026/0258824 A1
(43) Pub. Date: Sep. 3, 2026

(54) CONNECTOR FOR MECHANICALLY CONNECTING A FIRST COMPONENT AND A SECOND COMPONENT, CONNECTOR ASSEMBLY, BLOCKING ELEMENT, COMPONENT, COMPONENT ASSEMBLY, AND COMPONENT CONNECTION

(71) Applicant: Festool GmbH, Wendlingen (DE)

(72) Inventors: Steffen König, Schwaebisch Gmuend (DE); Vitus Rommel, Leningen (DE); David Grimm, Filderstadt (DE); Matthias Tenter, Esslingen a.N. (DE); David Messer, Zell unter Aichelberg (DE); Leon Bächle, Donnstetten-Roemerstein (DE)

(73) Assignee: Festool GmbH, Wendlingen (DE)

(21) Appl. No.: 19/489,957

(22) PCT Filed: Jun. 4, 2024
(86) PCT No.: PCT/EP2024/065356

§ 371 Date: Dec. 4, 2025

(30) Foreign Application Priority Data
Jun. 5, 2023 (DE) 10 2023 205 234.2

(51) Int. Cl. F16B 5/00; F16B 21/08

(52) U.S. Cl. CPC F16B 5/0052; F16B 21/086; F16B 2200/30; F16B 2200/71

(57) ABSTRACT

A connector mechanically connects a first component and a second component and has a central section, a first end section, and a second end section. The first end section and the second end section project beyond the central section on a first face of the central section. A projecting region of the first end section has a first holding surface, and a projecting region of the second end section has a second holding surface. At least one section of the first holding surface and/or at least one section of the second holding surface is inclined relative to the axis (A) of the central section when viewed perpendicularly to the first face of the central section. Components and component assemblies each have a component and a connector. A component connection has the components.

The invention relates to a connector for mechanically connecting a first component and a second component. The connector has a central portion, a first end portion, and a second end portion. The central portion extends along a central portion axis. The first end portion is arranged at a first end of the central portion and the second end portion is arranged at a second end of the central portion. The first end portion and the second end portion protrude relative to the central portion on a first side of the central portion.

The invention further relates to a connector assembly with such a connector and to a blocking element for a connector assembly.

The invention is additionally directed to a component with a component side, wherein a groove extending along a groove length direction is arranged in the component side and the groove has, along the groove length direction, a first groove portion, which has a constant groove width along a groove depth direction, and a second groove portion which adjoins the first groove portion. Adjacent the component side, the second groove portion has a first groove depth portion with a groove width which is reduced relative to the first groove portion and a second groove depth portion which adjoins the first groove depth portion on a side remote from the component side and has the same groove width as the first groove portion. Adjacent a side of the first groove depth portion remote from the component side, a retaining surface which forms an undercut effective contrary to the groove depth direction is formed on at least one side of the first groove depth portion. The invention is furthermore directed to a component assembly comprising such a component and a stated connector. The invention is also directed to a component connection with a first such component, a second such component, and a stated connector.

The invention further relates to use of a connector.

Such connectors, components, component assemblies, and component connections are known. They are used, in particular, for connecting components of wood.

In this respect, attempts are constantly being made to produce a mechanically stable component connection by way of the connector. At the same time, the connector needs to be of simple construction and easy to handle. There is a conflict in goals here between the mechanically stable component connection and the connector of simple construction which needs also to be easy to handle.

It is therefore the object of the present invention to resolve or at least mitigate this conflict, i.e., to provide a connector which is of structurally simple construction, with mechanically stable component connections being producible by way of the connector.

The object is achieved with a connector for mechanical connection of a first component and a second component. The connector has a central portion, a first end portion, and a second end portion. The central portion extends along a central portion axis. The first end portion is arranged at a first end of the central portion. The second end portion is arranged at a second end of the central portion. The first end portion and the second end portion protrude relative to the central portion on a first side of the central portion. A protruding region of the first end portion has a first retaining surface which faces the second end portion and is configured to hold the first component and the second component against one another. A protruding region of the second end portion has a second retaining surface which faces the first end portion and is configured to hold the first component and the second component against one another. At least one portion of the first retaining surface and/or at least one portion of the second retaining surface is/are inclined relative to the central portion axis in a view perpendicular to the first side of the central portion. The first end of the central portion is here arranged opposite the second end of the central portion. The first end and the second end are in each case understood to be ends along the central portion axis. The fact that the first retaining surface faces the second end portion means that a normal to the first retaining surface has a component which points in the direction of the second end portion. Accordingly, the fact that the second retaining surface faces the first end portion means that a normal to the second retaining surface has a component which points in the direction of the first end portion. In a situation where the connector is used to connect the first component and the second component, the first retaining surface and the second retaining surface of such a connector lie permanently against associated mating surfaces of the first component or the second component. This means that the connector is held against the first component by way of the first retaining surface and against the second component by way of the second retaining surface. Consequently, the first component and the second component are held against one another. The fact that at least one portion of the first retaining surface and/or at least one portion of the second retaining surface is/are inclined relative to the central portion axis means that the at least one portion of the first retaining surface and/or the at least one portion of the second retaining surface extend(s) neither parallel nor perpendicular to the central portion axis. The effect of the at least one portion of the first retaining surface and/or the at least one portion of the second retaining surface being inclined relative to the central portion axis is that the first component and the second component may be held against one another under tension by way of the connector. Owing to the slant, a force with which the connector is assembled with the first component and the second component is split into a force component acting along the assembly direction and into a force component which loads the first component and the second component toward one another. The latter force component may also be denoted a “contact force” since it leads to the first component and the second component being placed against one another or pressed against one another. Such a connection is particularly stable. In addition, such a connection is easy to make since the contact force is built up gradually on assembling the connector. At the same time, the connector is of structurally simple construction. The connector is preferably made in one piece. The connector thus in particular does not have any components which can be moved relative to one another. In one example, the connector takes the form of an injection molding.

In one preferred embodiment, in a view perpendicular to the first side of the central portion, the at least one portion of the first retaining surface and/or the at least one portion of the second retaining surface is/are inclined by an angle relative to the central portion axis which is smaller than a self-locking angle. In this way, it is ensured that the connector does not become undesirably detached from the first and/or second component. It goes without saying that, strictly speaking, the self-locking angle depends on a specific combination of a connector with a first component and a second component, since the self-locking angle is dependent on the respective materials. However, the self-locking angle can also be defined in such a way as to ensure self-locking of a connector of a known material relative to a first component and/or a second component of a specific material class. This means that the self-locking angle can be determined in a manner of speaking independently of the first component and independently of the second component. The self-locking angle can be determined, for example, for a connector of plastics material which is configured to connect a first component and a second component of wood. General material properties of wood are thus used to determine the self-locking angle.

The central portion axis preferably extends centrally or in the middle in the central portion. The central portion axis may therefore also be denoted central portion central axis.

In one example, in a view perpendicular to the first side of the central portion, the at least one portion of the first retaining surface is inclined by 3 degrees to 20 degrees, preferably by 5 degrees to 10 degrees, relative to the central portion axis. Alternatively or in addition, in a view perpendicular to the first side of the central portion, the at least one portion of the second retaining surface is inclined by 3 degrees to 20 degrees, preferably by 5 degrees to 10 degrees, relative to the central portion axis.

Irrespective of the magnitude of the inclination, the connector is thus asymmetric due to the slant of the at least one portion of the first retaining surface and/or of the at least one portion of the second retaining surface relative to a central plane of the central portion extending perpendicular to the central portion axis and centrally between the first end portion and the second end portion. As already explained above, however, the connector is nonetheless of structurally simple construction. This is the case, in particular, if the connector is made in one piece.

In the present case, a distinction must be drawn between a retaining surface as already defined above and an apposing surface. A retaining surface is configured, as already explained, to hold the first and second components permanently against one another when the connector is in the assembled state. In contrast, an apposing surface serves to place the first and second components against one another or to bring them into contact while the connection between the first and second components is being made. An apposing surface is thus used temporarily to make the connection, but not once the connection has been made. A typical example of an apposing surface is an “assembly bevel”. As the name suggests, this assists in fitting the connector to the first component and/or to the second component. Apposing surfaces thus do not transfer any retaining forces or generate any contact forces.

In one variant of the present invention, the first retaining surface and/or the second retaining surface is/are embodied as a combined retaining and apposing surface. This means that the first retaining surface and/or the second retaining surface serve in both the transfer of retaining forces and in placing the first component and the second component against one another or bringing them into contact, i.e., in generating a contact force. It should be emphasized that, in this variant too, the first retaining surface and/or the second retaining surface serve(s) constantly as a retaining surface.

The connector may have a first end surface at an end of the first end portion remote from the second end portion. The connector may have a second end surface at an end of the second end portion remote from the first end portion. The first end surface and/or the second end surface may, but need not, serve to guide the connector on the first component and/or on the second component. Preferably, the at least one portion of the first retaining surface, which in a view perpendicular to the first side of the central portion is inclined relative to the central portion axis, is also inclined relative to the first end surface in the view perpendicular to the first side of the central portion. Alternatively or in addition, the at least one portion of the second retaining surface, which in a view perpendicular to the first side of the central portion, is inclined relative to the central portion axis, is also inclined relative to the second end surface in the view perpendicular to the first side of the central portion. In the event that the first end surface and/or the second end surface is or are used to guide the connector, in this way a comparatively high contact force can be generated comparatively simply.

In one embodiment, the first end portion and the second end portion in each case protrude relative to the central portion on a second side of the central portion opposed to the first side. A region of the first end portion protruding relative to the second side has a third retaining surface which faces the second end portion and is configured to hold the first component and the second component against one another. A region of the second end portion protruding relative to the second side has a fourth retaining surface which faces the first end portion and is configured to hold the first component and the second component against one another. At least one portion of the third retaining surface and/or at least one portion of the fourth retaining surface is/are inclined relative to the central portion axis in a view perpendicular to the second side of the central portion. In a situation where the connector is used to connect the first component and the second component, the third retaining surface and the fourth retaining surface of such a connector lie permanently against associated mating surfaces of the first component or the second component. This means that the connector is held against the first component by way of the third retaining surface and against the second component by way of the fourth retaining surface. Consequently, the first component and the second component are held against one another. The fact that at least one portion of the third retaining surface and/or at least one portion of the fourth retaining surface is/are inclined relative to the central portion axis means that the at least one portion of the third retaining surface and/or the at least one portion of the fourth retaining surface extend(s) neither parallel nor perpendicular to the central portion axis. The effect of the at least one portion of the third retaining surface and/or the at least one portion of the fourth retaining surface being inclined relative to the central portion axis is that the first component and the second component may be held against one another under tension by way of the connector. Owing to the slant, a force with which the connector is assembled with the first component and the second component is split into a force component acting along the assembly direction and into a force component which loads the first component and the second component toward one another. The latter component may also be denoted a “contact force” since it leads to the first component and the second component being placed against one another or pressed against one another. In the present case, the first component and the second component may thus by fastened to one another by way of a total of four retaining surfaces. Such a connection is particularly stable. In addition, such a connection is easy to make since the contact force is built up gradually on assembling the connector. At the same time, the connector is of structurally simple construction. The connector is preferably made in one piece. The connector thus in particular does not have any components which can be moved relative to one another. In one example, the connector takes the form of an injection molding. Moreover, the above explanations relating to the first retaining surface and the second retaining surface apply mutatis mutandis also to the third retaining surface and the fourth retaining surface.

In one preferred embodiment, in a view perpendicular to the first side of the central portion, the at least one portion of the third retaining surface and/or the at least one portion of the fourth retaining surface is/are inclined by an angle relative to the central portion axis which is smaller than a self-locking angle. In this way, it is ensured that the connector does not become undesirably detached from the first and/or second component. It goes without saying that, strictly speaking, the self-locking angle depends on a specific combination of a connector with a first component and a second component, since the self-locking angle is dependent on the respective materials. However, the self-locking angle can also be defined in such a way as to ensure self-locking of a connector of a known material relative to a first component and/or a second component of a specific material class. This means that the self-locking angle can be determined in a manner of speaking independently of the first component and independently of the second component. The self-locking angle can be determined, for example, for a connector of plastics material which is configured to connect a first component and a second component of wood. General material properties of wood are thus used to determine the self-locking angle.

In one example, in a view perpendicular to the second side of the central portion, the at least one portion of the third retaining surface is inclined by 3 degrees to 20 degrees, preferably by 5 degrees to 10 degrees, relative to the central portion axis. Alternatively or in addition, in a view perpendicular to the second side of the central portion, the at least one portion of the fourth retaining surface is inclined by 3 degrees to 20 degrees, preferably by 5 degrees to 10 degrees, relative to the central portion axis.

In this case, the first retaining surface and the third retaining surface lie in a common plane or extend parallel to one another. Alternatively or in addition, the second retaining surface and the fourth retaining surface may lie in a common plane or extend parallel to one another. This results in a particularly simple connector structure. The fact that retaining surfaces lie in a common plane or extend parallel to one another additionally simplifies fitting of the connector to the first component and/or to the second component.

In one variant, at least one portion of the first retaining surface and at least one portion of the second retaining surface are inclined. The portion of the first retaining surface and the portion of the second retaining surface are in this case inclined in the same or opposing directions. Alternatively or in addition, at least one portion of the third retaining surface, and at least one portion of the fourth retaining surface are inclined. The portion of the third retaining surface and the portion of the fourth retaining surface are inclined in the same or opposing directions. The inclination in the same or opposing directions makes it possible to adjust the manner in which a contact force builds up on the basis of a relative motion between the connector and the first component and/or the second component. It may thus be ensured that the desired contact force is generated in a manner specific to the application.

In a view perpendicular to the first side of the central portion or in a view perpendicular to the second side of the central portion, the inclined portion of the first retaining surface and/or the inclined portion of the second retaining surface and/or the inclined portion of the third retaining surface and/or the inclined portion of the fourth retaining surface may intersect with the central portion axis. It goes without saying that the view perpendicular to the first side concerns the inclined portion of the first retaining surface and/or the inclined portion of the second retaining surface. The view perpendicular to the second side concerns the inclined portion of the third retaining surface and/or the inclined portion of the fourth retaining surface. This means that one or more of the inclined portion of the first retaining surface, the inclined portion of the second retaining surface, the inclined portion of the third retaining surface, and the inclined portion of the fourth retaining surface extend(s) in a central region of the connector with regard to a width of the connector which is oriented transversely of the central portion axis in a view perpendicular to the first side of the central portion or perpendicular to the second side of the central portion. The central region should here be understood as meaning a region encompassing the central portion axis. Accordingly, contact forces and resultant counterforces are introduced centrally into the connector at least in part with regard to the width thereof. This leads to a mechanically stable connection. Particularly high contact forces can also be generated and transferred in this way.

In one preferred example, in a view perpendicular to the first side of the central portion, both the inclined portion of the first retaining surface and the inclined portion of the second retaining surface intersect with the central portion axis. In another preferred example, in a view perpendicular to the second side of the central portion both the inclined portion of the third retaining surface and the inclined portion of the fourth retaining surface intersect with the central portion axis. It goes without saying that these two examples can also be combined.

According to one variant, the inclined portion of the first retaining surface and/or the inclined portion of the second retaining surface extend or extends over at least 30% of a width of the first side of the central portion. In this case, in a view perpendicular to the first side of the central portion, the width of the first side extends perpendicular to the central portion axis. Alternatively or in addition, the inclined portion of the third retaining surface and/or the inclined portion of the fourth retaining surface extend or extends over at least 30% of a width of the second side of the central portion. In this case, in a view perpendicular to the second side of the central portion, the width of the second side extends perpendicular to the central portion axis. At least one of the inclined portion of the first retaining surface, the inclined portion of the second retaining surface, the inclined portion of the third retaining surface, and the inclined portion of the fourth retaining surface thus extends over a significant proportion of the width of the central portion. Particularly high contact forces can therefore be transferred without causing a stress level within the connector to rise excessively. Thus, mechanically stable connections can be generated by way of the connector.

In one example, both the inclined portion of the first retaining surface and the inclined portion of the second retaining surface extend over at least 30% of the width of the first side of the central portion. In addition, both the inclined portion of the third retaining surface and the inclined portion of the fourth retaining surface extend over at least 30% of the width of the second side of the central portion. In this example, particularly high contact pressures may be transferred.

According to one embodiment, the first end portion and the second end portion in each case protrude on all sides relative to the central portion. The first end portion and the second end portion thus in each case protrude in the manner of a mushroom head relative to the central portion. Such a connector shape is comparatively simple. At the same time, a first retaining surface, a second retaining surface, a third retaining surface, and a fourth retaining surface may be simply configured.

At least one of the inclined portion of the first retaining surface, the inclined portion of the second retaining surface, the inclined portion of the third retaining surface, and the inclined portion of the fourth retaining surface may comprise at least two surface segments which are differently inclined relative to the central portion axis. In this case, the at least two surface segments are inclined to different degrees in the same direction. In the case of different relative or inserted positions of the connector relative to the first component and/or the second component, contact forces of differing magnitude may thus be generated between the first component and the second component by way of the differently inclined surface segments. Together, the at least two surface segments bring about a predefined profile for the contact force generated during relative motion between the connector and the first and/or second component. In this way, the desired contact force can be adjusted in two or more steps. A user can sense this on assembly by way of a resistance which they have to overcome during relative motion of the connector in relation to the first component or the second component. The user thus receives feedback as to whether the connector has been assembled with the first component and/or the second component in the desired manner.

At least one of the first retaining surface, second retaining surface, third retaining surface, and fourth retaining surface may also comprise a plateau portion. In a view perpendicular to the first side of the central portion or in a view perpendicular to the second side of the central portion, the plateau portion extends perpendicular to the central portion axis. In this case, the plateau portion is preferably positioned behind the central portion axis along a fitting direction of the connector. Within the plateau portion, contact forces between the first component and the connector and between the second component and the connector and thus between the first component and the second component are thus not increased if the connector is moved relative to the first component and/or to the second component. The plateau portion thus serves substantially to maintain a contact force already generated by way of the inclined portions. Due to the absence of inclination of the plateau portion, the latter additionally ensures that the connector is held reliably on the first component and/or on the second component. The plateau portion thus prevents undesired detachment of the connector from the first component and/or from the second component.

In one preferred example, all of the first retaining surface, second retaining surface, third retaining surface, and fourth retaining surface are provided with such a plateau portion.

It is also possible, in a view perpendicular to the first side of the central portion or in a view perpendicular to the second side of the central portion, for the plateau portion to extend substantially over the entire width of the first side or over the entire width of the second side. In other words, the plateau portion may extend over the entire, in each case associated first retaining surface and/or second retaining surface and/or third retaining surface and/or fourth retaining surface. This retaining surface thus extends as a whole perpendicular to the central portion axis if the connector is viewed in a direction perpendicular to the first side of the central portion or in a direction perpendicular to the second side of the central portion. The advantages and effects already mentioned above are particularly applicable for such a plateau portion. Furthermore, a retaining surface which is configured as a whole as a plateau is of comparatively simple construction. Consequently, an associated connector is also of comparatively simple construction.

In one example, in which the connector comprises a first retaining surface and a second retaining surface, one of the first and second retaining surfaces may extend perpendicular to the central portion axis in a view perpendicular to the first side of the central portion. The respective other one of the first and second retaining surfaces comprises at least one portion which is inclined relative to the central portion axis in a view perpendicular to the first side of the central portion.

In one example, in which the connector comprises a third retaining surface and a fourth retaining surface, one of the third and fourth retaining surfaces may extend perpendicular to the central portion axis in a view perpendicular to the second side of the central portion. The respective other one of the third and fourth retaining surfaces comprises at least one portion which is inclined relative to the central portion axis in a view perpendicular to the first side of the central portion.

According to one variant, at least one of the inclined portion of the first retaining surface, the inclined portion of the second retaining surface, the inclined portion of the third retaining surface, and the inclined portion of the fourth retaining surface comprises at least two elasticity segments which exhibit different degrees of elastic resilience. As already explained, in the assembled state, the retaining surfaces rest against corresponding mating surfaces on the first component and/or on the second component. The elastic resilience of the at least two elasticity segments results in generation of a contact force component on elastic deformation of the at least two elasticity segments. The connector may thus be held reliably against the first component and/or against the second component.

In one preferred example, each of the inclined portion of the first retaining surface, the inclined portion of the second retaining surface, the inclined portion of the third retaining surface, and the inclined portion of the fourth retaining surface has at least two elasticity segments which exhibit different degrees of elastic resilience.

According to one variant, at least one of the first retaining surface, second retaining surface, third retaining surface, and fourth retaining surface is elastically resilient at least in part. As explained above, in the assembled state, the retaining surfaces rest against corresponding mating surfaces on the first component and/or on the second component. The elastic resilience results in generation of a contact force component on elastic deformation. The connector may thus be held reliably against the first component and/or against the second component. In addition, the elastic resilience may result in tolerance compensation. Furthermore, compressive behavior of the first component and/or of the second component, which are connected by way of the connector, can be compensated by appropriately selecting or adjusting elastic resilience. In this way, on the one hand a reliable connection is ensured as well as good assemblability of the connector, i.e., good connectability.

In one example, in which at least one of the first component and second component is a wooden component, the connector, or more precisely the elastic resilience of the connector, may thus be configured to connect at least one comparatively hard wooden component to another component, for example to a further wooden component, which may likewise be comparatively hard. In this example, the elastic resilience may be selected to be comparatively significant.

In another example, in which at least one of the first component and second component is a wooden component, the connector, or more precisely the elastic resilience of the connector, may be configured to connect at least one comparatively soft wooden component to another component, for example to a further wooden component, which may likewise be comparatively soft. In this example, the elastic resilience may be selected to be comparatively slight.

In this respect, at least one portion of the first retaining surface, the second retaining surface, the third retaining surface, and/or the fourth retaining surface may be formed by a spring element. The spring element in particular takes the form of a leaf spring element. The at least one portion of the first retaining surface, the second retaining surface, the third retaining surface, and/or the fourth retaining surface is thus formed by a surface of the spring element, in particular by a surface of the leaf spring element.

In one example, in which the connector comprises a first retaining surface and a second retaining surface, one of the first and second retaining surfaces may be elastically resilient, at least in part. The respective other one of the first and second retaining surfaces is not elastically resilient or at least has a very much lower level of elastic resilience. This allows reliable retention to be achieved by way of the contact force component, together with tolerance compensation, the connector additionally being of structurally simple construction.

In one example, in which the connector comprises a third retaining surface and a fourth retaining surface, one of the third and fourth retaining surfaces may be elastically resilient, at least in part. The respective other one of the third and fourth retaining surfaces is not elastically resilient or at least has a very much lower level of elastic resilience. This allows reliable retention to be achieved by way of the contact force component, together with tolerance compensation, the connector additionally being of structurally simple construction.

In one variant configuration, at least one of the inclined portion of the first retaining surface, the inclined portion of the second retaining surface, the inclined portion of the third retaining surface, and the inclined portion of the fourth retaining surface has at least one segment with surface texturing. Thanks to the surface texturing, such a portion has increased surface roughness compared with the other portions of the associated retaining surface. As a result, the connector may be retained particularly reliably on the first component and/or on the second component. Undesired loosening of the connection, generated by way of the connector, of the first component and the second component is thus reliably prevented.

In a view along the central portion axis, the first end portion and/or the second end portion may be asymmetric. In the event of an opening being formed in the first component and/or in the second component with a compatible geometry, this may ensure that the first end portion and/or the second end portion can only be inserted into the opening in the first component and/or in the second component in a single predetermined orientation. Thus, incorrect insertion of the first end portion and/or of the second end portion can be prevented. In other words, the connector is of mistake-proof configuration. This simplifies handling and use of the connector.

In one example, the first end portion and/or the second end portion have/has an edge-side recess, which results in asymmetry if the respective end portion is viewed along the central portion axis. In this example, an opening in the first component and/or in the second component has to have a projection corresponding to the recess, in order to achieve the above-stated functions and effects.

According to one alternative configuration, an elastically resilient end surface is provided on a side of the second end portion remote from the first end portion. Alternatively or in addition, an elastically resilient end surface is provided on a side of the first end portion remote from the second end portion. The elastically resilient end surface provided on the first end portion is thus opposite the first retaining surface and/or the third retaining surface. The elastic resilience of the end surface on the first end portion may thus be used to press the first retaining surface and/or the third retaining surface against a mating surface provided on the first component or on the second component, a contact force component being generated by way of elastic deformation of the end surface. The elastically resilient end surface provided on the second end portion is thus opposite the second retaining surface, and/or the fourth retaining surface. The elastic resilience of the end surface on the second end portion may thus be used to press the second retaining surface and/or the fourth retaining surface against a mating surface provided on the first component or on the second component, a contact force component being generated by way of elastic deformation of the end surface. The connector may thus be held reliably against the first component or against the second component.

According to one embodiment, at least one of the first retaining surface, second retaining surface, third retaining surface, and fourth retaining surface is mounted in elastically resilient manner in a direction toward the central portion axis. In a case where the connector comprises both a first retaining surface and a third retaining surface, preferably both the first retaining surface and the third retaining surface are mounted in elastically resilient manner in a direction toward the central portion axis. In a case where the connector comprises both a second retaining surface and a fourth retaining surface, preferably both the second retaining surface and the fourth retaining surface are mounted in elastically resilient manner in a direction toward the central portion axis. This elastically resilient mounting may be achieved by the portion of the connector which comprises the at least one of the first retaining surface, second retaining surface, third retaining surface, and fourth retaining surface being mounted in elastically resilient manner relative to the other portions of the connector. For example, the portion which comprises the at least one of the first retaining surface, second retaining surface, third retaining surface, and fourth retaining surface is mounted in elastically bendable, elastically compressible and/or elastically twistable manner relative to the other portions of the connector. As already explained, the first retaining surface, the second retaining surface, the third retaining surface, and the fourth retaining surface are configured to engage in a component-side undercut, i.e., in an undercut which is provided on the first component or on the second component. Such an undercut has an effective direction, i.e., a direction along which the respectively relevant first retaining surface, second retaining surface, third retaining surface, and/or fourth retaining surface form(s) an interlocking connection with the component-side undercut. The elastically resilient mounting may, in this respect, make it possible for the respectively relevant first retaining surface, second retaining surface, third retaining surface and/or fourth retaining surface to be inserted into the undercut contrary to the effective direction of the undercut, i.e., moved toward the undercut contrary to the effective direction, in order to be brought into engagement with the undercut. In this case, as a result of the associated elastically resilient mounting, the respectively relevant first retaining surface, second retaining surface, third retaining surface, and/or fourth retaining surface can temporarily adopt a position, before engagement in the associated undercut, in which the respectively relevant first retaining surface, second retaining surface, third retaining surface, and/or fourth retaining surface have/has moved closer to the central portion axis. As soon as the respectively associated undercut is reached, the respectively relevant first retaining surface, second retaining surface, third retaining surface and/or fourth retaining surface are/is moved out of this temporary position, so as to engage in the respectively associated undercut. In other words, the respectively relevant first retaining surface, second retaining surface, third retaining surface, and/or fourth retaining surface can be clipped into the respectively associated undercut in the manner of a clip connection. In this way, a connection can be made particularly quickly and easily between the first component or the second component and the connector.

The connector may also comprise a blocking projection, which is configured to fix the connector in place in a groove. In this case, in a view perpendicular to the first side of the central portion or in a view perpendicular to the second side of the central portion, the blocking projection juts out laterally from the central portion and/or from one of the first end portion and second end portion. In other words, in such a view, the blocking projection projects laterally relative to the central portion and/or relative to one of the first end portion and second end portion. Such a blocking projection makes it possible to restrict freedom of movement within a groove in the first component or the second component of a portion of the connector accommodated in the groove if the groove is larger in at least one dimension than the accommodated portion of the connector. The blocking projection reduces the size difference between the portion of the connector and the groove, so restricting freedom of movement. The size of the connector including blocking projection preferably corresponds to the size of the groove. In this way, the freedom of movement can be reduced substantially to zero. Provision of a blocking projection thus enables the connector to be made compatible with different grooves. Any differences in size or geometry which may be present may be compensated by way of the blocking projection. Furthermore, by providing the blocking projection, it is possible to predetermine an introduction direction in which the connector is introduced into an associated groove. For example, the blocking projection may force the connector to be introduced, for example clipped, thereinto only along the groove depth direction. In this way, reliable coupling between the connector and the first component and/or the second component can be achieved. Furthermore, the blocking projection may prevent the connector from moving relative to the first component while the connector is being coupled with the second component, or vice versa. In this way too, a reliable connection is achieved between the first component and the second component.

Furthermore, the object is achieved by a connector assembly which comprises a connector according to the invention and a blocking element. The blocking element is separate from the connector. Furthermore, the blocking element can be applied against the connector in order to fix the connector in place in a groove. The blocking element is block-shaped or barrel-shaped, for example. Such a blocking element makes it possible to restrict freedom of movement within a groove in the first component or the second component of a portion of the connector accommodated in the groove if the groove is larger in at least one dimension than the accommodated portion of the connector. The blocking element is, to this end, likewise positioned at least in part in the groove, so reducing any space between the portion of the connector and the groove. Freedom of movement of the connector within the groove is thus reduced. The size of the portion of the connector accommodated in the groove and the size of the portion of the blocking element accommodated in the groove preferably together correspond to the size of the groove. In this way, the freedom of movement can be reduced substantially to zero. Provision of a blocking element thus enables the connector to be made compatible with different grooves. In this respect, it is possible, for example, for blocking elements of different shapes and/or sizes to be combined with the same connector. In this respect, blocking elements of different widths can be used in grooves of different widths, such that the same connector can always be used. Furthermore, by providing the blocking element, it is possible to predetermine an introduction direction in which the connector is introduced into an associated groove. For example, the blocking element may force the connector to be introduced, for example clipped, thereinto only along the groove depth direction. In this way, reliable coupling between the connector and the first component and/or the second component can be achieved. Furthermore, the blocking element may prevent the connector from moving relative to the first component while the connector is being coupled with the second component, or vice versa. In this way too, a reliable connection is achieved between the first component and the second component.

The object is also achieved by a blocking element for a connector assembly according to the invention. As already mentioned, the blocking element is separate from the connector. Furthermore, the blocking element is configured to be applied against the connector in order to fix the connector in place in a groove. The blocking element is block-shaped or barrel-shaped, for example. Such a blocking element makes it possible to restrict freedom of movement within a groove in the first component or the second component of a portion of the connector accommodated in the groove if the groove is larger in at least one dimension than the accommodated portion of the connector. The blocking element is, to this end, likewise positioned at least in part in the groove, so reducing any space between the portion of the connector and the groove. Freedom of movement of the connector within the groove is thus reduced. The size of the portion of the connector accommodated in the groove and the size of the portion of the blocking element accommodated in the groove preferably together correspond to the size of the groove. In this way, the freedom of movement can be reduced substantially to zero.

Provision of a blocking element thus enables the connector to be made compatible with different grooves. In this respect, it is possible, for example, for blocking elements of different shapes and/or sizes to be combined with the same connector.

The object is furthermore achieved by a component. The component comprises a first surface adjacent a component edge, a second surface adjacent the component edge, and a recess which interrupts a portion of the first surface, a portion of the second surface, and the component edge. In this case, the recess has a first portion which interrupts the first surface, the second surface, and the component edge, and a second portion which adjoins the first portion at an end remote from the second surface and forms an undercut effective in the direction of the second surface. In this alternative, a wall surface forming the undercut is inclined relative to the second surface in a view along the component edge. In other words, in a view along the component edge, the wall surface forming the undercut is at different distances from the second surface at different heights measured starting from the first surface. The first portion of the recess is cuboidal, for example. The fact that the second portion forms an undercut effective in the direction of the second surface, means that a component, in particular a connector, which engages in the second portion is prevented from moving in the direction of the second surface due to the undercut. This may be used to fasten the component to another component by way of the connector or to connect the component to an other component. By way of the slant of the wall surface, a contact force can be generated in the event of a connector having been inserted into the recess, by means of which contact force the component can be applied or pressed against another component. The component can thus be fastened under tension to another component. Here once again, the fact that the wall surface is inclined means that the wall surface extends neither parallel nor perpendicular to the second surface if this is viewed along the component edge. Owing to the slant, a force with which the connector is assembled with the first component is split into a force component acting along the assembly direction and into a force component which loads the component relative to another second component. The latter force component may also be denoted a “contact force” since it leads to the first component and the second component being placed against one another or pressed against one another. A stable component connection, which is additionally easy to create, can thus be obtained.

In one preferred embodiment, the wall surface is inclined at an angle which is less than a self-locking angle. In this way, it is ensured that a connector does not become undesirably detached from the component. It goes without saying that, strictly speaking, the self-locking angle depends on a specific combination of a connector with the component, since the self-locking angle is dependent on the respective materials. However, the self-locking angle can also be defined in such a way as to ensure self-locking of a component of a known material relative to a connector of a specific material class. This means that the self-locking angle can be determined in a manner of speaking independently of the connector. The self-locking angle can be determined for a component of a known material, for example for a connector of plastics material.

The component according to the invention is made from a derived timber product, for example.

In one preferred variant, the first surface and the second surface are oriented perpendicularly to one another.

The component according to the invention may in this case interact with a connector according to the invention. Alternatively, the component may interact with a non-inventive connector which, in particular, does not have any inclined portions of retaining surface. In the latter example in particular, the configuration of the recess in the component according to the invention may be understood as a kinematic reversal of the functional principle already explained on the basis of the connector according to the invention. In simpler terms, the inclined portion of the retaining surface may either be provided on the connector or on the recess. A combination is likewise possible.

In one example, in a view along the component edge, the wall surface is inclined by 3 degrees to 20 degrees, preferably by 5 degrees to 10 degrees, relative to the second surface.

The second portion may project relative to the first portion on both sides in a direction parallel to the component edge. In this case, in a direction parallel to the component edge and on both sides in the projecting regions of the second portion, a wall surface may face away from the second surface and form an undercut effective in the direction of the second surface. The wall surfaces are then inclined relative to the second surface in a view along the component edge. In other words, in a view along the component edge, the wall surfaces forming the undercut are at different distances from the second surface at different heights measured starting from the first surface. By way of the slant of the wall surfaces, a contact force can again be generated in the event of a connector having been inserted into the recess, by means of which contact force the component can be applied or pressed against another component. The component can thus be fastened under tension to another component. Owing to the slant, a force with which the connector is assembled with the first component is split into a force component acting along the assembly direction and into a force component which loads the component relative to another second component. The latter force component may also be denoted a “contact force” since it leads to the first component and the second component being placed against one another or pressed against one another. A stable component connection can thus be created.

In one example, in a view along the component edge, the wall surfaces are inclined by 3 degrees to 20 degrees, preferably by 5 degrees to 10 degrees, relative to the second surface.

In one variant, a wall surface comprises at least two wall surface segments which are differently inclined relative to the second surface. In this case, the at least two wall surface segments are inclined to different degrees in the same direction. In the case of different relative or inserted positions of the connector relative to the component, contact forces of differing magnitude may thus be generated between the first component and the second component by way of the differently inclined wall surface segments. Together, the at least two wall surface segments bring about a predefined profile for the contact force generated during relative motion between connector and component. In this way, the desired contact force can be adjusted in two or more steps. A user can sense this on assembly by way of a resistance which they have to overcome during relative motion of the connector in relation to the component. The user thus receives feedback as to whether the connector has been assembled with the component in the desired manner.

At least one wall surface may comprise a plateau portion which, in a view along the component edge, extends parallel to the second surface. Within the plateau portion, contact forces between the first component and the connector and between the second component and the connector and thus between the first component and the second component are thus not increased if the connector is moved relative to the component. The plateau portion thus serves substantially to maintain an already-generated contact force.

Alternatively or in addition, at least one wall surface may comprise at least two elasticity segments which exhibit different degrees of elastic resilience. As already explained, a connector may rest against the wall surfaces. The elastic resilience of the at least two elasticity segments results in generation of a contact force component on elastic deformation of the at least two elasticity segments. The connector may thus be held reliably on the component.

At least one wall surface may also have at least one segment with surface texturing. Thanks to the surface texturing, such a segment has increased surface roughness compared with the other segments of the associated wall surface. As a result, the connector may be held particularly reliably on the component. Undesired loosening of the connector arranged in the recess is thus reliably prevented.

Furthermore, the object is achieved by a component assembly which comprises a component and a connector. In this case, the component is a component according to the invention and/or the connector is a connector according to the invention. The component assembly may thus be configured according to three variants. In a first variant, the component is a component according to the invention, but the connector is not according to the invention. Such a connector may have a first retaining surface and a second retaining surface, wherein, in a view perpendicular to the first side of the central portion, the two retaining surfaces are oriented perpendicular relative the central portion axis. Moreover, the non-inventive connector may be constructed like the connector according to the invention. In a second variant, the connector is a connector according to the invention, but the component is not according to the invention. In this case, the component may have a wall surface forming an undercut, which wall surface extends parallel to the second surface and may otherwise be constructed like the component according to the invention. In a third variant, the component is a component according to the invention and/or the connector is a connector according to the invention. In all the variants, the connector is placed in the recess in the component in such a way that the first end portion lies in the second portion of the recess and at least the first retaining surface of the connector is opposite the wall surface of the recess. In other words, the first retaining surface is in contact at least in part with the wall surface. In this case, according to the variants explained, either the first retaining surface of the connector is inclined and/or the wall surface of the recess is inclined. As already explained in respect to the component according to the invention and the connector according to the invention, when the connector is assembled with the component, a contact force is generated which results in the connector and the component being reliably connected.

Furthermore, the object is achieved by a component connection with a first component, a second component, and a connector. In this case, the first component and/or the second component are components according to the invention. Alternatively or in addition, the connector is a connector according to the invention. The alternatives explained in respect to the component assembly are thus obtained for the subassembly of first component and connector. The alternatives explained in respect to the component assembly are likewise obtained for the subassembly of second component and connector. In all the variants, the second surface of the first component and the second surface of the second component rest against one another. The first surface of the first component and the first surface of the second component lie in a common plane. The connector is placed in the recess in the component and in the recess in the second component in such a way that the first end portion lies in the second portion of the recess in the first component and at least the first retaining surface of the connector is opposite the wall surface of the second portion of the recess in the first component. The second end portion of the connector is placed in the second portion of the recess in the second component. In this case, at least the second retaining surface lies opposite the wall surface of the second portion of the recess in the second component. In other words, the first component and the second component are connected by way of the connector. In this case, at least the first retaining surface of the connector rests against the wall surface of the second portion of the recess in the first component and at least the second retaining surface of the connector rests against the wall surface of the second portion of the recess in the second component. As already explained in respect to the connector according to the invention and the component according to the invention, a contact force is generated in the process. The first component and the second component are thus connected reliably and stably by means of the connector.

The object is additionally achieved by a component with a component side, wherein a groove extending along a groove length direction is arranged in the component side and the groove has, along the groove length direction, a first groove portion, which has a constant groove width along a groove depth direction, and a second groove portion which adjoins the first groove portion. Adjacent the component side, the second groove portion has a first groove depth portion with a groove width which is reduced relative to the first groove portion and a second groove depth portion which adjoins the first groove depth portion on a side remote from the component side and has the same groove width as the first groove portion, wherein, adjacent a side of the first groove depth portion remote from the component side, a retaining surface which forms an undercut effective contrary to the groove depth direction is formed on at least one side of the first groove depth portion. The retaining surface is inclined relative to the groove depth direction. The retaining surface is thus neither parallel nor perpendicular to the groove depth direction. In other words, the retaining surface forming the undercut is at different distances from the component side at different longitudinal positions of the groove. In this case, the retaining surface is oriented in such a way that there is a minimal distance between the retaining surface and the component side adjacent to the first groove portion and a maximal distance between the retaining surface and the component side at an end remote from the first groove portion. Owing to the undercut, a component, in particular a connector, which engages in the second groove depth portion is prevented from moving in the direction of the component side due to the undercut. This may be used to fasten the component to another component by way of the connector or to connect it to another component. Owing to the slant of the retaining surface, a contact force can be generated in the event of a connector having been inserted into the groove, by means of which contact force the component can be applied or pressed against another component. The component can thus be fastened under tension to another component. Owing to the slant, a force with which the connector is assembled with the first component is split into a force component acting along the assembly direction and into a force component which loads the component relative to another second component. The latter force component may also be denoted a “contact force” since it leads to the first component and the second component being placed against one another or pressed against one another. A stable component connection can thus be simply created.

In one preferred embodiment, the retaining surface is inclined by an angle relative to the groove depth direction which is smaller than a self-locking angle. In this way, it is ensured that a connector does not become undesirably detached from the component. It goes without saying that, strictly speaking, the self-locking angle depends on a specific combination of a connector with the component, since the self-locking angle is dependent on the respective materials. However, the self-locking angle can also be defined in such a way as to ensure self-locking of a component of a known material relative to a connector of a specific material class. This means that the self-locking angle can be determined in a manner of speaking independently of the connector. The self-locking angle can be determined for a component of a known material, for example for a connector of plastics material.

The Component According to the Invention Is Made From a Derived Timber Product, for Example.

The component according to the invention may in this case interact with a connector according to the invention. Alternatively, the component may interact with a non-inventive connector which in particular does not have any inclined portion of the retaining surface. In the latter example in particular, the configuration of the groove in the component according to the invention may be understood as a kinematic reversal of the functional principle of the connector. In simpler terms, the inclined portion of the retaining surface may either be provided on the connector or in the groove. A combination is likewise possible.

In one example, the retaining surface is inclined by 3 degrees to 20 degrees, preferably by 5 degrees to 10 degrees, relative to the component side.

According to one variant, adjacent the side of the first groove depth portion remote from the component side on both sides along a direction parallel to the groove width, a retaining surface which forms an undercut effective contrary to the groove depth direction is formed in each case on the first groove depth portion. Both retaining surfaces are inclined relative to the groove depth direction. In other words, the retaining surfaces forming the undercut are at different distances from the component side at different longitudinal positions of the groove. In this case, the retaining surfaces are oriented in such a way that there is a minimal distance between the respective retaining surface and the component side adjacent to the first groove portion and a maximal distance between the respective retaining surface and the component side at an end remote from the first groove portion. By way of the slant of the retaining surfaces, a contact force can again be generated in the event of a connector having been inserted into the groove, by means of which contact force the component can be applied or pressed against another component. The component can thus be fastened under tension to another component. Owing to the slant, a force with which the connector is assembled with the first component is split into a force component acting along the assembly direction and into a force component which loads the component relative to another second component. The latter force component may also be denoted a “contact force” since it leads to the first component and the second component being placed against one another or pressed against one another. A stable component connection can thus be simply created.

In one example, the two retaining surfaces are inclined by 3 degrees to 20 degrees, preferably by 5 degrees to 10 degrees, relative to the component side.

At least one retaining surface may comprise at least two retaining surface segments which are differently inclined relative to the groove depth direction. In this case, the at least two retaining surface segments are inclined to different degrees in the same direction. In the case of relative motion of the connector relative to the component, contact forces of differing magnitude may thus be generated by means of the differently inclined retaining surface segments. Together, the at least two retaining surface segments bring about a predefined profile for the contact force generated during relative motion. This means that in different inserted positions of the connector, different contact forces are generated. In this way, the desired contact force can be adjusted in two or more steps. A user can sense this on assembly by way of a resistance which they have to overcome during relative motion of the connector in relation to the component. The user thus receives feedback as to whether the connector has been assembled with the first component and/or to the second component in the desired manner.

Alternatively or in addition, at least one retaining surface may comprise a plateau portion which extends perpendicular to the groove depth direction. Within the plateau portion, contact forces are thus not increased or reduced if the connector is moved relative to the component. The plateau portion thus serves substantially to preserve an already-generated contact force.

At least one retaining surface may also comprise at least two elasticity segments which exhibit different degrees of elastic resilience. As already explained, a connector may rest against the wall surfaces. The elastic resilience of the at least two elasticity segments results in generation of a contact force component on elastic deformation of the at least two elasticity segments. The connector may thus be held reliably on the component. The connector is additionally easy to assemble with the component.

It is likewise possible for at least one retaining surface to have at least one segment with surface texturing. Thanks to the surface texturing, such a portion has increased surface roughness compared with the other portions of the associated retaining surface. As a result, the connector may be held particularly reliably on the component. Undesired loosening of the connector arranged in the recess is thus reliably prevented.

Furthermore, the object is achieved by a component assembly which comprises a component and a connector. In this case, the component is a component according to the invention and/or the connector is a connector according to the invention. The component assembly may thus be configured according to three variants. In a first variant, the component is a component according to the invention, but the connector is not according to the invention. Such a connector may have a first retaining surface and a second retaining surface, wherein, in a view perpendicular to the first side of the central portion, the two retaining surfaces are oriented perpendicular relative the central portion axis. Moreover, the non-inventive connector may be constructed like the connector according to the invention. In a second variant, the connector is a connector according to the invention, but the component is not according to the invention. In this case, the component may have a retaining surface forming an undercut, which retaining surface extends perpendicular to the groove depth and may otherwise be constructed like the component according to the invention. In a third variant, the component is a component according to the invention and/or the connector is a connector according to the invention. In all the variants, the connector is placed in the groove in the component in such a way that the first end portion lies in the second groove depth portion and at least the first retaining surface of the connector is opposite the retaining surface of the groove. In other words, the first retaining surface of the connector is in contact at least in part with the retaining surface of the groove. In this case, according to the variants explained, either the first retaining surface of the connector is inclined and/or the retaining surface of the groove is inclined. As already explained in respect to the component according to the invention and the connector according to the invention, when the connector is assembled with the component, a contact force is generated which results in the connector and the component being reliably connected.

The object is also achieved by a component connection with a first component and a second component, and a connector. In this case, the first component and/or the second component is a component according to the invention. Alternatively or in addition, the connector is a connector according to the invention. The alternatives explained in respect to the component assembly are thus obtained for the subassembly of first component and connector. The alternatives explained in respect to the component assembly are likewise obtained for the subassembly of second component and connector. In all the variants, the component side of the first component and the component side of the second component rest against one another. Furthermore, in all the variants, the connector is placed in the groove in the first component in such a way that the first end portion lies in the second groove depth portion and at least the first retaining surface of the connector is opposite the retaining surface of the groove. Depending on the variant, the first retaining surface of the connector and/or the retaining surface of the groove is/are inclined. Furthermore, the connector is placed in the groove in the second component in such a way that the end portion lies in the second groove depth portion and at least the second retaining surface of the connector is opposite the retaining surface of the groove. Depending on the variant, the second retaining surface of the connector and/or the second retaining surface of the groove is/are inclined. In other words, the first component and the second component are connected by way of the connector. In this case, at least the first retaining surface of the connector rests against the retaining surface of the groove in the first component and at least the second retaining surface of the connector rests against the retaining surface of the groove in the second component. As already explained in respect to the connector according to the invention and the component according to the invention, a contact force is generated in the process. The first component and the second component are thus connected reliably and stably by means of the connector.

According to one embodiment, the component connection comprises a blocking element, which has been inserted into the groove in the first component or into the groove in the second component. In this case, the blocking element blocks movement of the connector within the groove in the first component or within the groove in the second component or restricts movement play of the connector within the groove in the first component or within the groove in the second component. The connector is thus particularly highly reliably anchored in the groove in the first component or in the groove in the second component. Such a blocking element may also be designated a blind plug.

The object is also achieved by using a connector according to the invention for connecting a first component and a second component. As already explained, such a connector is configured to connect the first component and the second component mechanically stably and highly reliably. Using the connector according to the invention thus gives rise to a mechanically stable and reliable component connection.

Furthermore, the features, effects and advantages stated in respect to one of the connector according to the invention, the components according to the invention, the component assemblies according to the invention, the component connections according to the invention and use according to the invention also apply to the respective other ones of the connector according to the invention, the components according to the invention, the component assemblies according to the invention, the component connections according to the invention and use according to the invention. The above-stated examples and variants may thus be combined, irrespective of whether they are mentioned in respect to the connector according to the invention, the components according to the invention, the component assemblies according to the invention, the component connections according to the invention or use according to the invention.

The invention will be explained below with reference to various exemplary embodiments shown in the appended drawings, in which:

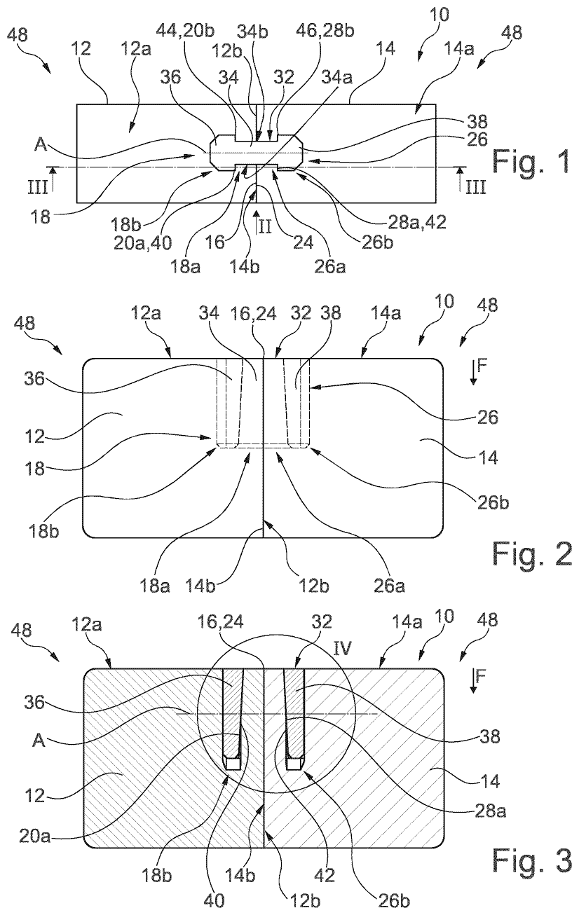

FIG. 1 is a plan view of an inventive component connection according to a first embodiment with an inventive component assembly according to a first embodiment and an inventive connector according to a first embodiment,

FIG. 2 shows the component connection of FIG. 1 in a side view along direction II of FIG. 1,

FIG. 3 shows the component connection of FIGS. 1 and 2 in sectional view along plane III-III of FIG. 1,

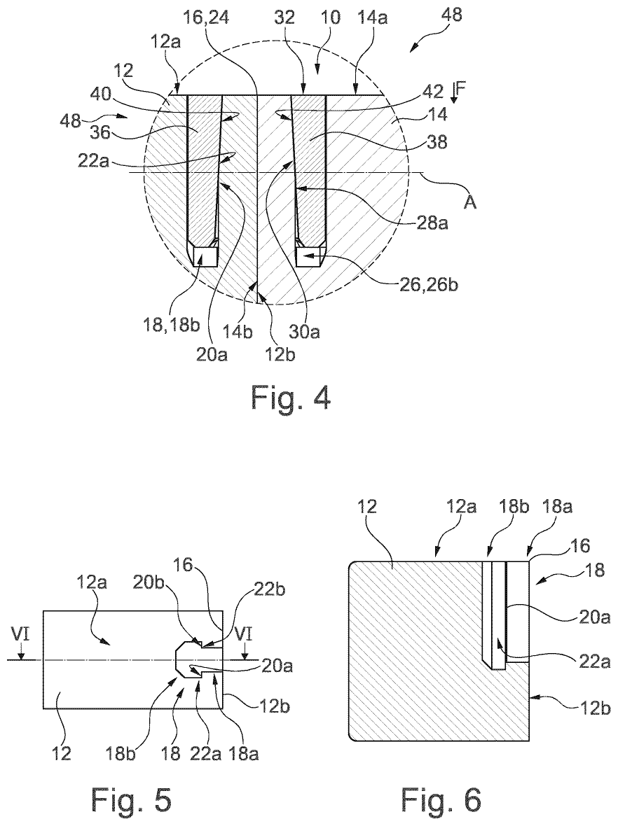

FIG. 4 shows a detail IV of the component connection of FIG. 3,

FIG. 5 is a separate view of the component of the component connection depicted on the left in FIG. 1,

FIG. 6 shows the component of FIG. 5 in a sectional representation along plane VI-VI of FIG. 5,

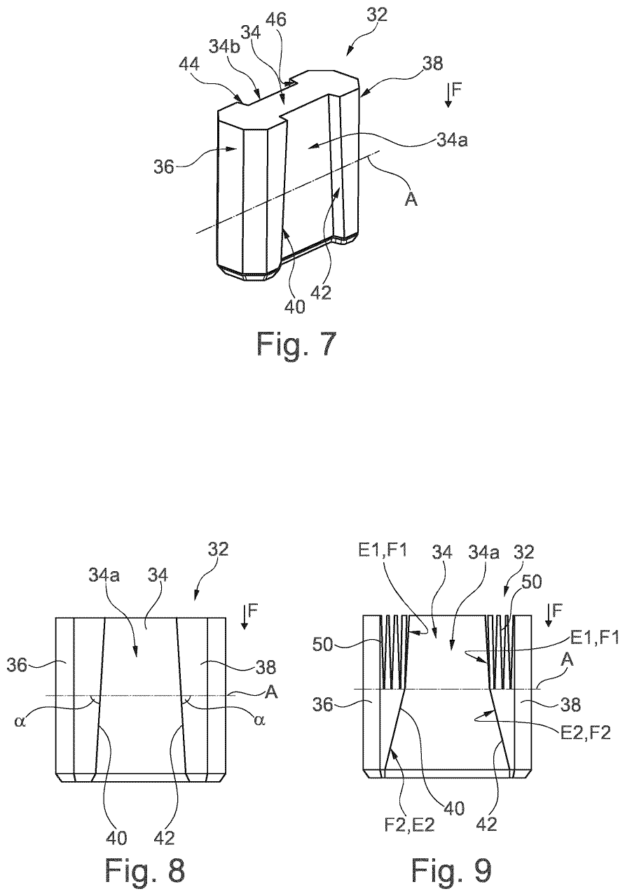

FIG. 7 is a separate, perspective representation of the connector according to the first embodiment of the component connection according to the first embodiment of FIGS. 1 to 3,

FIG. 8 is a side view of the connector according to the first embodiment of FIG. 7,

FIG. 9 is a side view of an inventive connector according to a second embodiment,

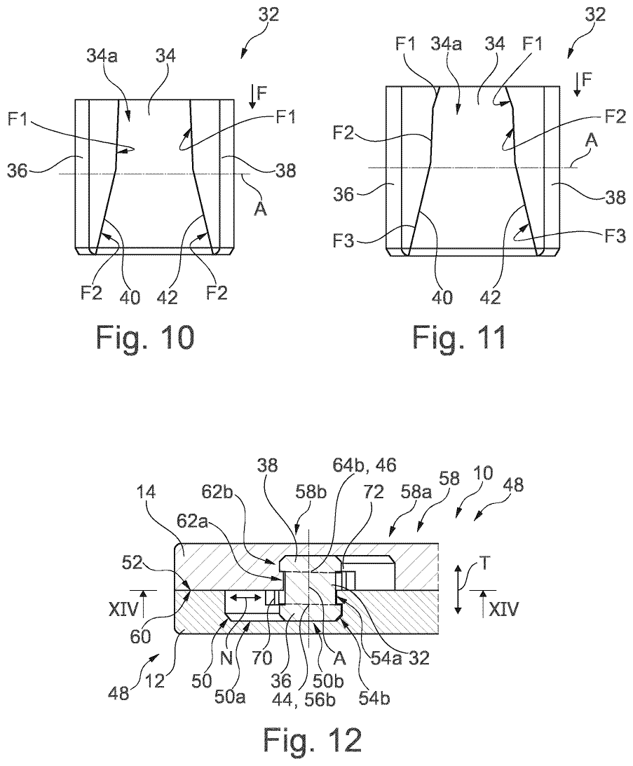

FIG. 10 is a side view of an inventive connector according to a third embodiment,

FIG. 11 is a side view of an inventive connector according to a fourth embodiment,

FIG. 12 is a sectional side view of an inventive component connection according to a second embodiment with an inventive component assembly according to a second embodiment and an inventive connector according to a fifth embodiment,

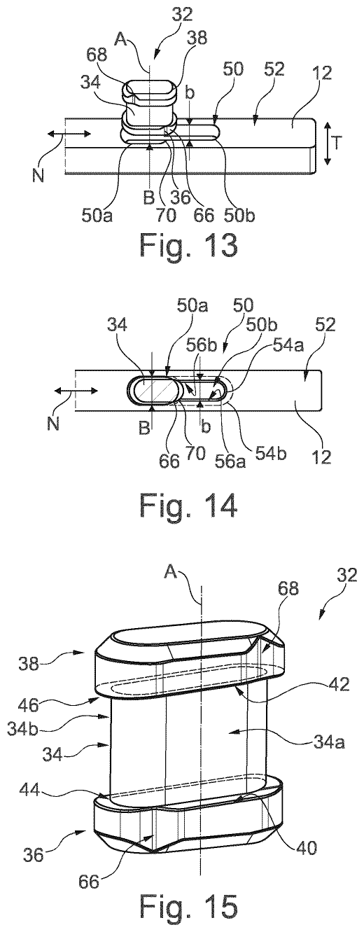

FIG. 13 shows an intermediate state during production of the component connection of FIG. 12, wherein specifically the connector is inserted into the groove in the first component,

FIG. 14 shows a further intermediate state during production of the component connection of FIG. 12, wherein the connector has been inserted into a first groove portion of the groove in the first component, wherein the connector is depicted in sectional representation for better visibility,

FIG. 15 is a separate, perspective representation of the connector according to the fifth embodiment of the component connection according to the second embodiment of FIG. 12,

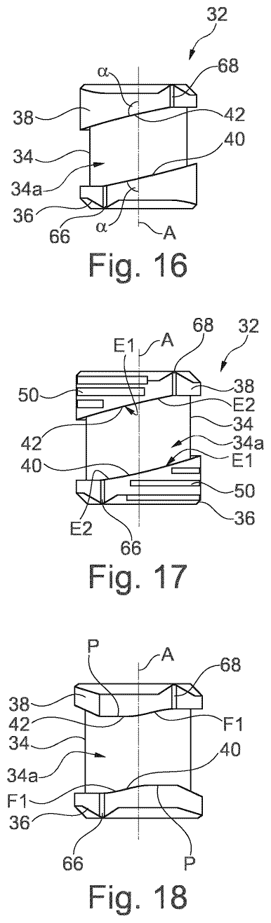

FIG. 16 is a side view of the connector according to the sixth embodiment,

FIG. 17 is a side view of an inventive connector according to a seventh embodiment,

FIG. 18 is a side view of an inventive connector according to an eighth embodiment,

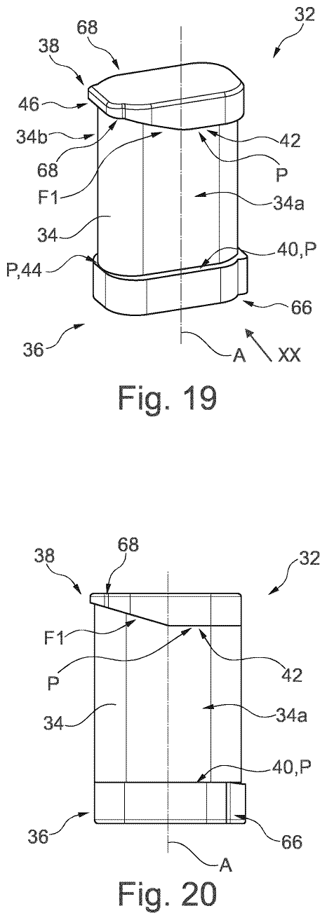

FIG. 19 is a perspective representation of an inventive connector according to a ninth embodiment,

FIG. 20 shows the connector of FIG. 19 in a side view along direction XX in FIG. 19,

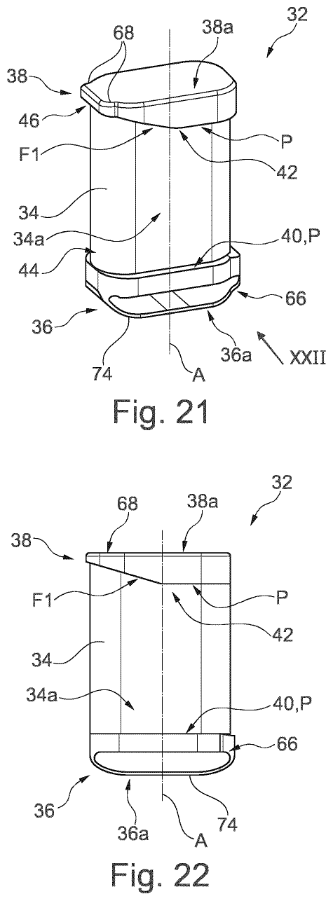

FIG. 21 is a perspective representation of an inventive connector according to a tenth embodiment,

FIG. 22 shows the connector of FIG. 21 in a side view along direction XXII in FIG. 21,

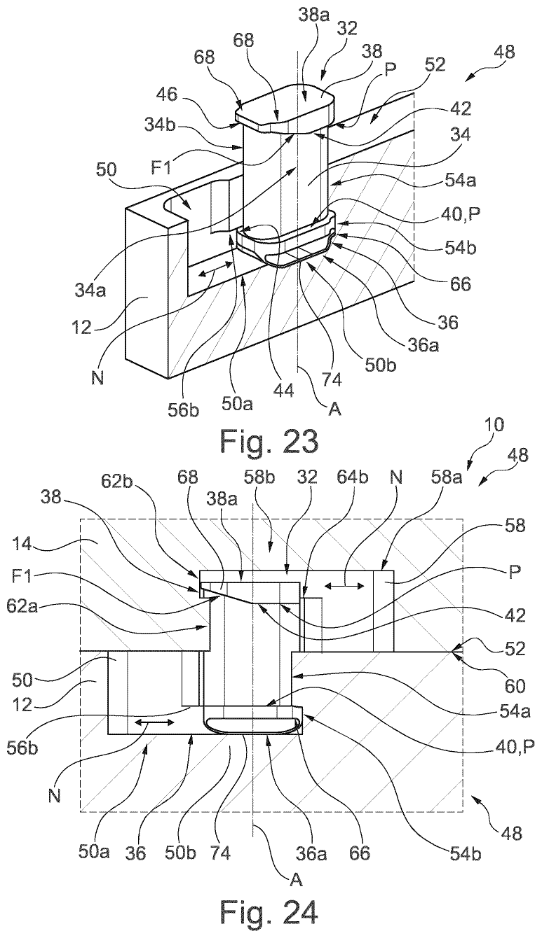

FIG. 23 shows an inventive component assembly comprising the connector according to the tenth embodiment, wherein the first component into which the connector has been inserted is depicted in sectional representation,

FIG. 24 shows an inventive component connection comprising the connector according to the tenth embodiment, wherein the first component and the second component of the component connection are depicted in sectional representation,

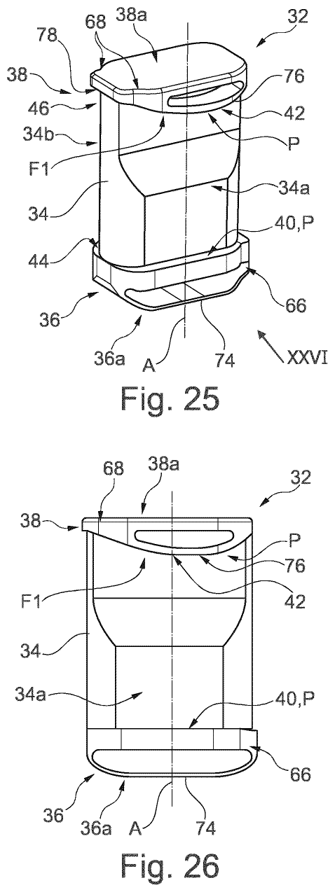

FIG. 25 is a perspective representation of an inventive connector according to an eleventh embodiment,

FIG. 26 shows the connector of FIG. 25 in a side view along direction XXVI of FIG. 25,

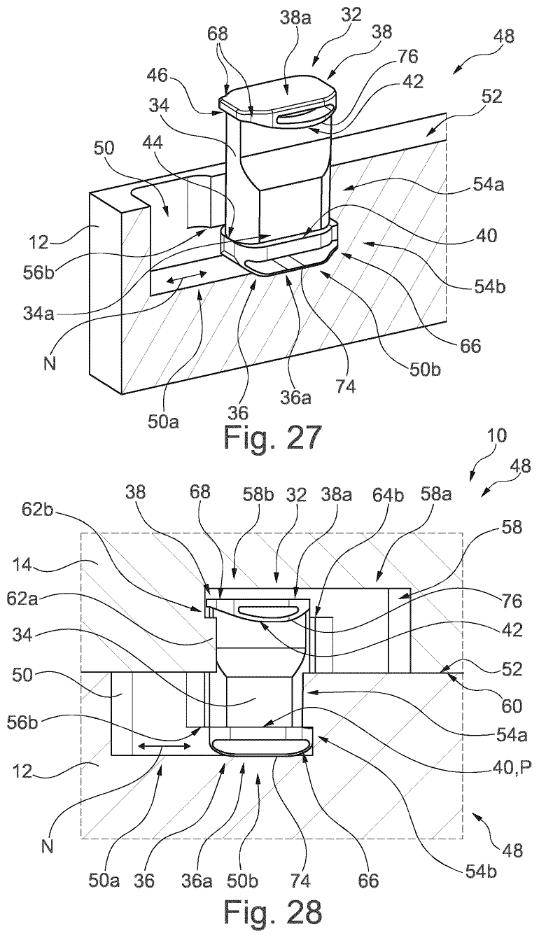

FIG. 27 shows an inventive component assembly comprising the connector according to the eleventh embodiment, wherein the first component into which the connector has been inserted is depicted in sectional representation,

FIG. 28 shows an inventive component connection comprising the connector according to the eleventh embodiment, wherein the first component and the second component of the component connection are depicted in sectional representation,

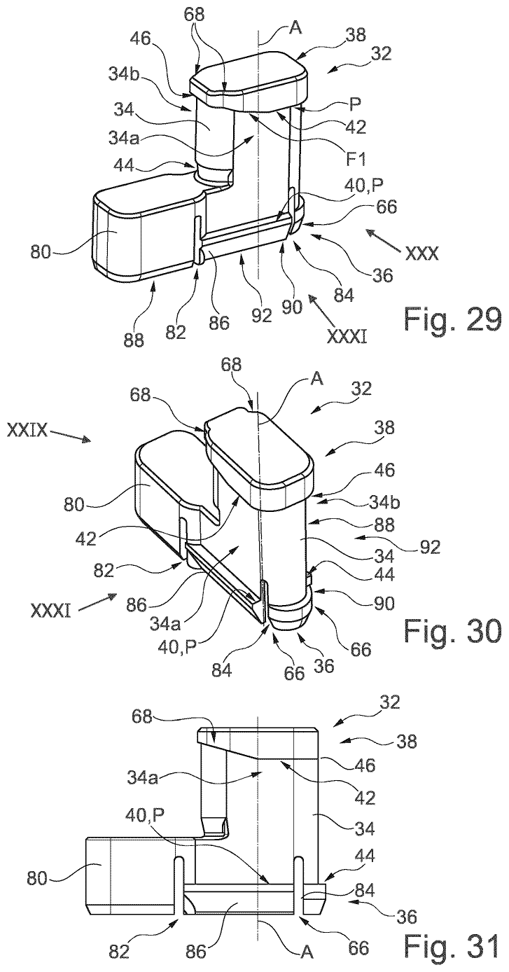

FIG. 29 is a perspective representation of an inventive connector according to a twelfth embodiment, wherein the direction of view extends along direction XXIX of FIG. 30,

FIG. 30 is a different perspective representation of the connector of FIG. 29, wherein the direction of view extends along direction XXX of FIG. 29,

FIG. 31 shows the connector of FIGS. 29 and 30 in a side view along directions XXXI of FIGS. 29 and 30,

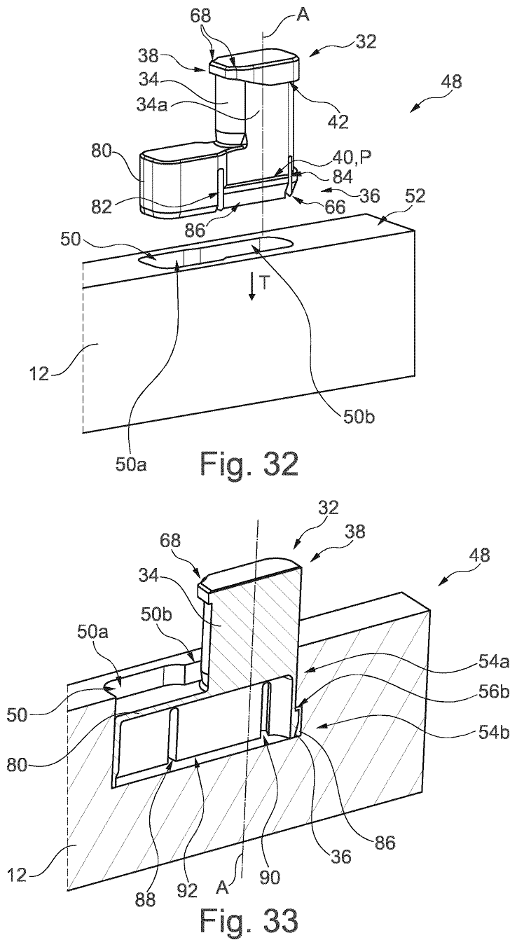

FIG. 32 is an exploded representation of an inventive component assembly comprising the connector of FIGS. 29 to 31,

FIG. 33 shows an inventive component assembly comprising the connector according to the twelfth embodiment, wherein both the first component into which the connector has been inserted and the connector are depicted in sectional representation,

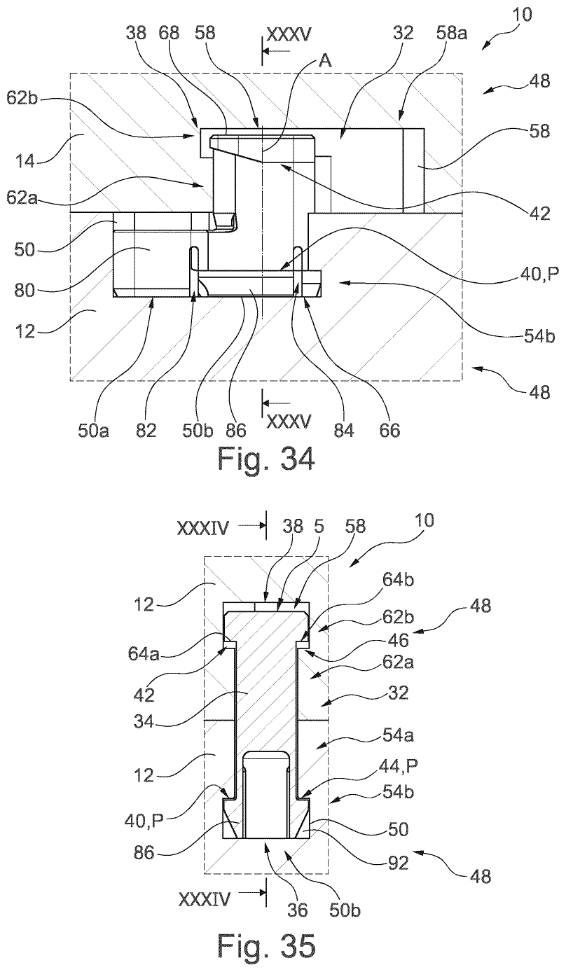

FIG. 34 shows an inventive component connection comprising the connector according to the twelfth embodiment, wherein the first component and the second component of the component connection are depicted in sectional representation in a plane X. XIV-XXXIV of FIG. 35,

FIG. 35 shows the component connection of FIG. 34, wherein the first component and the second component of the component connection are depicted in sectional representation in a plane XXXV-XXXV of FIG. 34,

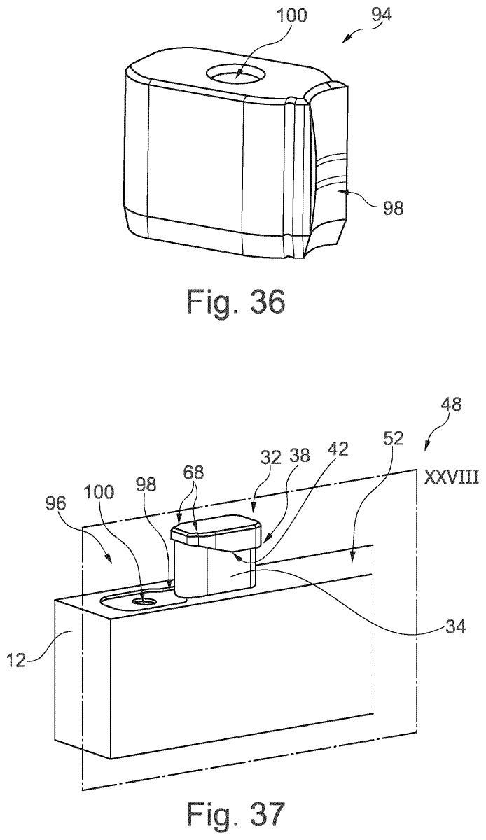

FIG. 36 is a separate perspective representation of an inventive blocking element of an inventive connector assembly,

FIG. 37 shows an inventive component assembly comprising a first component as well as the connector according to the ninth embodiment, wherein the connector is fixed in the associated groove using the blocking element of FIG. 36,

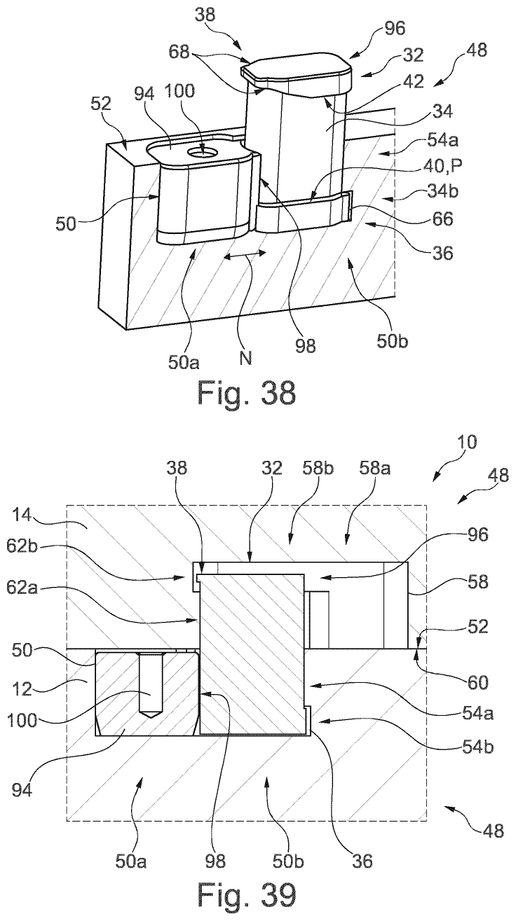

FIG. 38 shows the component assembly of FIG. 37, wherein the first component is depicted in sectional representation in plane XXXVIII of FIG. 37, and

FIG. 39 shows an inventive component connection comprising a first component and a second component as well as the connector according to the ninth embodiment, wherein the connector is fixed in the associated groove using the blocking element of FIG. 36 and wherein the first component, the second component, the connector, and the blocking element are depicted in sectional representation.

FIG. 1 shows a component connection 10 comprising a first component 12 and a second component 14.

In the embodiments depicted, both the first component 12 and the second component 14 are made from a derived timber product.

In this case, the first component 12 has a first surface 12a and a second surface 12b which adjoin a common component edge 16.

The first surface 12a and the second surface 12b are oriented at right angles to one another.

The first component 12 further comprises a recess 18 which interrupts a portion of the first surface 12a, a portion of the second surface 12b, and the component edge 16.

The recess 18 comprises a first portion 18a, which is cuboidal (see in particular also FIGS. 5 and 6). The first portion 18a interrupts the first surface 12a, the second surface 12b and the component edge 16.

The recess further comprises a second portion 18b. The second portion 18b adjoins the first portion 18a, specifically at an end of the first portion 18a remote from the second surface 12b. The second portion 18b and the second surface 12b are thus positioned at opposing ends of the first portion 18a.

The second portion 18b protrudes relative to the first portion 18a on both sides in a direction parallel to the component edge 16. In other words, the second portion 18b projects relative to the first portion 18a on both sides in a direction parallel to the component edge 16. In the depicted embodiment, the second portion 18b is also substantially cuboidal, the two edges facing away from the first portion 18a being beveled.

The second portion 18b is larger than the first portion 18a along a direction parallel to the component edge 16.

The two portions of the second portion 18b projecting relative to the first portion 18a are in each case bounded by a wall surface 20a, 20b, both of which point away from the second surface 12b. This means that a surface normal to each of the wall surfaces 20a, 20b points away from the second surface 12b.

The wall surfaces 20a, 20b thus in each case form an undercut 22a, 22b effective in a direction relative to the second surface 12b.

In the depicted embodiment, the wall surfaces 20a, 20b extend parallel to the second surface 12b.

The second component 14 also has a first surface 14a and a second surface 14b which adjoin a common component edge 24.

The first surface 14a and the second surface 14b are oriented at right angles to one another.

The second component 14 further comprises a recess 26, which corresponds in shape to the recess 18 in the first component 12 but is arranged as a mirror image thereof. The second surface 14b here constitutes a mirror plane.

The recess 26 interrupts a portion of the first surface 14a, a portion of the second surface 14b, and the component edge 24.

The recess 26 again comprises a first portion 26a which is cuboidal (likewise see FIGS. 5 and 6). The first portion 26a interrupts the first surface 14a, the second surface 14b and the component edge 24.

The recess 26 further comprises a second portion 26b. The second portion 26b adjoins the first portion 26a, specifically at an end of the first portion remote from the second surface 14b. The second portion 26b and the second surface 14b are thus positioned at opposing ends of the first portion 26a.

The second portion 26b protrudes relative to the first portion 26a on both sides in a direction parallel to the component edge 24. In other words, the second portion 26b projects relative to the first portion 26a on both sides in a direction parallel to the component edge 24. In the depicted embodiment, the second portion 26b is also substantially cuboidal, the two edges facing away from the first portion 26a being beveled.

The second portion 26b is larger than the first portion 26a along a direction parallel to the component edge 24.

The two portions of the second portion 26b projecting relative to the first portion 26a are in each case bounded by a wall surface 28a, 28b, both of which face away from the second surface 14b. This means that a surface normal to each of the wall surfaces 28a, 28b points away from the second surface 14b.

The wall surfaces 28a, 28b thus in each case form an undercut 30a, 30b effective in a direction relative to the second surface 14b.

In the depicted embodiment, the wall surfaces 28a, 28b extend parallel to the second surface 14b

In the component connection 10, the first component 12 and the second component 14 are arranged in such a way that the second surface 12b of the first component 12 and the second surface 14b of the second component 14 rest against one another. Furthermore, the first surface 12a of the first component 12 and the first surface 14a of the second component 14 lie in a common plane.

Moreover, the recess 18 in the first component 12 and the recess 26 in the second component 14 lie opposite one another. More precisely, the interruptions formed by the first portion 18a of the recess 18 in the second surface 12b of the first component 12 and the interruption formed by the first portion 26a of the recess 26 in the second surface 14b of the second component 14 lie opposite one another.

The component connection 10 further comprises a connector 32, which is configured according to a first embodiment in FIG. 1.

The connector 32 according to the first embodiment is depicted in detail in FIGS. 7 and 8.

The connector 32 comprises a central portion 34, a first end portion 36 and a second end portion 38.

In this case, the central portion 34 extends along a central portion axis A which extends centrally through the central portion 34. The central portion axis A may thus also be denoted central portion central axis.

In the case of the connector 32 according to the first embodiment, the central portion axis A extends perpendicular to a joining direction F, which is illustrated in the figures by an arrow.

Furthermore, the central portion 34 is plate-shaped. The central portion 34 thus has two opposingly oriented flat sides, which are of substantially equal size and which are much larger than the other surfaces bounding the central portion 34.

A first side 34a of the central portion 34 is formed by the first flat side and a second side 34b of the central portion 34 by a second flat side.

Along the central portion axis A, the first end portion 36 is arranged at a first end of the central portion 34 and the second end portion 38 is arranged at a second end of the central portion 34.

The first end of the central portion 34 and the second end of the central portion 34 are opposite one another.

Both the first end portion 36 and the second end portion 38 protrude relative to the central portion 34 on a first side 34a of the central portion 34.

Likewise, both the first end portion 36 and the second end portion 38 protrude relative to the central portion 34 on the second side 34b of the central portion 34.

In this case, a region of the first end portion 36 protruding on the first side 34a has a first retaining surface 40. The first retaining surface 40 faces the second end portion 38.

This means that a surface normal of the first retaining surface 40 has a component which points in the direction of the second end portion 38.

The first retaining surface 40 is configured to hold the first component 12 and the second component 14 against one another, as will be explained below in further detail.

A region of the second end portion 38 protruding on the first side 34a has a second retaining surface 42. The second retaining surface 42 faces the first end portion 36. This means that a surface normal of the second retaining surface 42 has a component which points in the direction of the first end portion 36.

The second retaining surface 42 is also configured to hold the first component 12 and the second component 14 against one another, as will be explained below in further detail.

Furthermore, a region of the first end portion 36 protruding on the second side 34b has a third retaining surface 44. The third retaining surface 44 faces the second end portion 38. This means that a surface normal of the third retaining surface 44 has a component which points in the direction of the second end portion 38.

The third retaining surface 44 is likewise configured to hold the first component 12 and the second component 14 against one another, as will be explained below in further detail.

Moreover, a region of the second end portion 38 protruding on the second side 34b has a fourth retaining surface 46. The fourth retaining surface 46 faces the first end portion 36. This means that a surface normal of the fourth retaining surface 46 has a component which points in the direction of the first end portion 36.

The fourth retaining surface 46 is also configured to hold the first component 12 and the second component 14 against one another, as will be explained below in further detail.

In this case, in the depicted first embodiment of the connector 32, the first retaining surface 40 and the second retaining surface 42 are in each case inclined overall relative to the central portion axis A in a view perpendicular to the first side 34a. This means that the entire first retaining surface 40 and the entire second retaining surface 42 extend neither parallel nor perpendicular to the central portion axis A.

The first retaining surface 40 and the second retaining surface 42 here extend substantially over the entire width of the connector 32, the width being measured perpendicular to the central portion axis A in a view perpendicular to the first side 34a.

In this case, in the view perpendicular to the first side 34a of the central portion 34, both the first retaining surface 40 and the second retaining surface 42 intersect with the central portion axis A.

In the depicted embodiment, the first retaining surface 40 forms an angle α of approximately 80° with the central portion axis A. The same applies to the second retaining surface 42 and the central portion axis A.

The first retaining surface 40 and the second retaining surface 42 are inclined such that they are convergent. The first retaining surface 40 and the second retaining surface 42 are thus inclined in opposing directions (see FIG. 8).

Likewise, in the depicted embodiment, the third retaining surface 44 and the fourth retaining surface 46 are in each case inclined overall relative to the central portion axis A in a view perpendicular to the second side 34b. This again means that the entire third retaining surface 44 and the entire fourth retaining surface 46 extend neither parallel nor perpendicular to the central portion axis A.

The third retaining surface 44 and the fourth retaining surface 46 here extend substantially over the entire width of the connector 32, the width being measured perpendicular to the central portion axis A in a view perpendicular to the second side 34b.

In this case, in the view perpendicular to the second side 34b of the central portion 34, both the third retaining surface 44 and the fourth retaining surface 46 intersect with the central portion axis A.

In the depicted embodiment, the third retaining surface 44 forms an angle α of approximately 80° with the central portion axis A. The same applies to the fourth retaining surface 46 and the central portion axis A.

The third retaining surface 44 and the fourth retaining surface 46 are inclined such that they are convergent. The third retaining surface 44 and the fourth retaining surface 46 are thus inclined in opposing directions.

In this case, the first retaining surface 40 and the third retaining surface 44 lie in a common plane.

Likewise, the second retaining surface 42 and the fourth retaining surface 46 lie in a common plane.

A side view perpendicular to the second side 34b of the connector 32 thus corresponds to the side view shown in FIG. 8 onto the first side 34a of the connector.

An edge of the connector 32 depicted at the bottom in FIGS. 7 and 8 is furthermore provided with chamfers, which simplify insertion of the connector into the recess 18 in the first component 12 and the recess 26 in the second component 14. In this case, the chamfers lie at the front along the joining direction F.

In the component connection 10, the connector 32 is placed both in the recess 18 in the first component 12 and in the recess 26 in the second component 14. In this case, the connector 32 terminates flush with the first surface 12a of the first component 12 and the first surface 14a of the second component 14 (see FIGS. 1 to 4).

In this case, the first end portion 36 of the connector 32 is arranged in the second portion 18b of the recess 18 in the first component 12.

The second end portion 38 of the connector 32 is accordingly placed in the second portion 26b of the recess 26 in the second component 14.

Furthermore, the first retaining surface 40 of the connector 32 rests against the wall surface 20a of the recess 18 in the first component 12.

The second retaining surface 42 of the connector 32 rests against the wall surface 28a of the recess 26 in the second component 14.

The third retaining surface 44 of the connector 32 rests against the wall surface 20b of the recess 18 in the first component 12.

The fourth retaining surface 46 of the connector 32 rests against the wall surface 28b of the recess 26 in the second component 14.

The slant of the first retaining surface 40, the second retaining surface 42, the third retaining surface 44, and the fourth retaining surface 46 here ensures that the first component 12 and the second component 14 rest against one another under tension. The first component 12 and the second component 14 may in this case be compressed in part, in particular in the region of the wall surfaces 20a, 20b, 28a, 28b.

In a case where the connector 32 connects the first component 12 and the second component 14, the connector 32 additionally rests against an outer contour of the recesses 18, 26 on all sides at the level of the first surfaces 12a, 14a. In a view according to FIG. 1 there is thus no gap between the connector 32 and the first component 12. There is likewise no gap between the connector 32 and the second component 14.

In a case where the connector 32 has been inserted solely into the recess 18 in the first component 12 or into the recess 26 in the second component 14, the combination of first component 12 or second component 14 and the connector 32 may also be denoted component assembly 48.

FIG. 9 shows a connector 32 according to a second embodiment. Only the differences with regard to the connector 32 according to the first embodiment will be explained below.

In the case of the connector 32 according to the second embodiment, each of the retaining surfaces 40, 42, 44, 46 comprises two surface segments F1, F2 which, though inclined in the same direction, are inclined by different degrees relative to the central portion axis A.

Furthermore, each of the retaining surfaces 40, 42, 44, 46 has two elasticity segments E1, E2, which in the present case are congruent with the above-stated surface segments F1, F2.

In this respect, the elastic resilience of the first elasticity segments E1 is greater than the elastic resilience of elasticity segments E2.

This is achieved by providing slot-shaped recesses 50 in the region of elasticity segments E1. For the sake of greater clarity, in FIG. 9 only some of the slot-shaped recesses 50 are provided with a reference sign.

The connector 32 according to the second embodiment can be inserted into the recess 18 in the first component 12 and/or into the recess 26 in the second component 14 in the same way as the connector 32 according to the first embodiment.

The greater elastic resilience of the elasticity segments E1 here ensures particularly good retention of the connector 32 in the recesses 18, 26.

FIG. 10 shows a connector 32 according to a third embodiment. Only the differences with regard to the first and second embodiments of the connector 32 will be addressed here.

The connector 32 according to the third embodiment substantially corresponds to the connector 32 according to the second embodiment. However, the connector according to the third embodiment does not have any elasticity segments.

FIG. 11 depicts a connector according to a fourth embodiment.

Again, only the differences with regard to the exemplary embodiments already explained will be addressed.

In the case of the connector 32 according to the fourth embodiment, each of the retaining surfaces 40, 42, 44, 46 comprises a total of three surface segments F1, F2, F3 which, though inclined in the same direction, are inclined by different degrees relative to the central portion axis A.

In a further embodiment which is not depicted, a surface segment may extend perpendicular to the central portion axis A in each of the retaining surfaces 40, 42, 44, 46. Such a surface segment is also denoted “plateau segment”.

According to a further variant which is not depicted, in each of the embodiments of the connector 32 which have already been explained, at least one segment of the first retaining surface 40, of the second retaining surface 42, of the third retaining surface 44, and/or of the fourth retaining surface 46 may exhibit surface texturing. The surface texturing serves to anchor the connector 32 reliably in the first component 12 and/or in the second component 14.

In the examples according to FIGS. 1 to 11, retaining surfaces 40, 42, 44, 46 are provided on the connector 32 which extend in inclined manner relative to the central portion axis A. These retaining surfaces 40, 42, 44, 46 may in each case interact with the wall surfaces 20a, 20b, 28a, 28b of the first component 12 and the second component 14 in order to bring about a mechanically stable and reliable component connection 10. In the examples according to FIGS. 1 to 11, the wall surfaces 20a, 20b, 28a, 28b extend substantially parallel to the second surface 12b of the first component 12 and to the second surface 14b of the second component 14.

Alternatively, this mode of action may be kinematically reversed.

This means that the retaining surfaces 40, 42, 44, 46 on the connector 32 may, but need not, continue to extend as explained with reference to FIGS. 1 to 11. In this respect, in a view perpendicular to the first side 34a and/or in a view perpendicular to the second side 34b, the retaining surfaces 40, 42, 44, 46 of the connector 32 may be oriented perpendicular to the central portion axis A.

In this alternative, the wall surfaces 20a, 20b are then inclined relative to the second surface 12b in a view along component edge 16.

The wall surfaces 28a, 28b are inclined in the same way in a view along component edge 24.

This gives rise to a mechanically stable and reliable component connection 10.

It goes without saying that, in this alternative, in accordance with the explanations given for FIGS. 9 to 11, wall surface segments may be provided which are inclined by different degrees relative to the second surface 12b or the second surface 14b.

It is further possible for the wall surfaces 20a, 20b, 28a, 28b to have plateau segments. The plateau segments in each case extend parallel to the second surface 12b or to the second surface 14b. The above explanations in relation to the plateau segments of the connector 32 apply mutatis mutandis in this respect.

The wall surfaces 20a, 20b, 28a, 28b may also have segments with surface texturing.

FIG. 12 shows a component connection 10 according to a second embodiment. The component connection 10 again comprises the first component 12, the second component 14, and a connector 32.

However, the first component 12 is differently configured here from in the first embodiment of the component connection 10.

The first component 12 here comprises a groove 50 which extends along a groove length direction N.

The groove 50 is unilaterally open to a component side 52, i.e., the groove 50 only interrupts the component side 52 and not other component sides of the first component 12.

Along the groove length direction N, the groove 50 has a first groove portion 50a and a second groove portion 50b. The first groove portion 50 and the second groove portion 50b merge into one another.

The first groove portion 50a has a groove width B which is constant along a groove depth direction T of the first groove portion 50 (see also FIG. 14).

In this respect, the groove depth direction T is perpendicular to the surface in which the associated groove, here the groove 50, is provided. The groove depth direction T is thus perpendicular to the component side 52.

Looking at the groove 50 along a direction perpendicular to the component side 52 reveals that the groove has a greater extent along one direction than in a second direction, the first direction and the second direction being perpendicular to one another. In this case, the groove length direction N corresponds to the first direction, i.e., the direction of greater extent, and the groove width direction, i.e., the direction of the groove width B, corresponds to the second direction, i.e., the direction of lesser extent.

The second groove portion 50b is divided into two groove depth portions 54a, 54b. In this case, a first groove depth portion 54a is arranged adjacent the component side 52. The first groove depth portion 54a has a reduced groove width b relative to the first groove portion 50a (see also FIG. 14).

The second groove depth portion 54b directly adjoins the first groove depth portion 54a. This means that the second groove depth portion 54b is arranged on the opposite side of the first groove depth portion 54a from the component side 52.

The second groove depth portion 54b has the same groove width B as the first groove portion 50a.

In this case, the groove 50 is configured such that the second groove depth portion 54b protrudes relative to the first groove depth portion 54a on both sides in a direction parallel to the groove widths b, B.

In this way, retaining surfaces 56a, 56b are formed on both sides on the side of the first groove depth portion 54a remote from the component side 52, these retaining surfaces 56a, 56b forming an undercut effective contrary to the groove depth direction T.

The second component 14 also comprises a groove 58, which corresponds geometrically to the groove 50 in the first component 12 but is arranged in mirror-inverted manner in the second component 14.

In this case, the groove 58 in the second component 14 also extends along a groove length direction N.

The groove 58 is likewise unilaterally open to a component side 60 of the second component 14, i.e., the groove 58 only interrupts the component side 60 and not other component sides of the second component 14.

Along the groove length direction N, the groove 58 also has a first groove portion 58a and a second groove portion 58b. The first groove portion 58a and the second groove portion 58b merge into one another.

The first groove portion 58a has a groove width B which is constant along a groove depth direction T of the first groove portion 58.

The second groove portion 58b is divided into two groove depth portions 62a, 62b. In this case, a first groove depth portion 62a is arranged adjacent the component side 60. The first groove depth portion 62a has a reduced groove width b relative to the first groove portion 58a.

The second groove depth portion 62b directly adjoins the first groove depth portion 62a. This means that the second groove depth portion 62b is arranged on the opposite side of the first groove depth portion 62a from the component side 60.

The second groove depth portion 62b has the same groove width B as the first groove portion 58a.

In this case, the groove 58 is configured such that the second groove depth portion 62b protrudes relative to the first groove depth portion 62a on both sides in a direction parallel to the groove widths b, B.

In this way, retaining surfaces 64a, 64b are formed on both sides on the side of the first groove depth portion 62a remote from the component side 60, these retaining surfaces 64a, 64b forming an undercut effective contrary to the groove depth direction T.

Since the groove 58 corresponds geometrically to the groove 50, reference may also be made to FIG. 14 with regard to the geometric shape of the groove 58.

The connector 32 of the component connection 10 according to the second embodiment is depicted in detail in FIG. 15. This is a connector 32 according to a fifth embodiment.

The connector 32 comprises a central portion 34, a first end portion 36 and a second end portion 38.

In this case, the central portion 34 extends along a central portion axis A which extends centrally through the central portion 34. The central portion axis A may thus also be denoted central portion central axis.

Furthermore, the central portion 34 is plate-shaped. The central portion 34 thus has two opposingly oriented flat sides, which are of substantially equal size and which are much larger than the other surfaces bounding the central portion 34.

A first side 34a of the central portion is formed by the first flat side and a second side 34b of the central portion by a second flat side.

Along the central portion axis A, the first end portion 36 is arranged at a first end of the central portion 34 and the second end portion 38 is arranged at a second end of the central portion 34.

The first end of the central portion 34 and the second end of the central portion 34 are opposite one another.

In the connector 32 according to the fifth embodiment, both the first end portion 36 and the second end portion 38 protrude relative to the central portion 34 on all sides.

In this case, a region of the first end portion 36 protruding on the first side 34a has a first retaining surface 40. The first retaining surface 40 faces the second end portion 38. This means that a surface normal of the first retaining surface 40 has a component which points in the direction of the second end portion 38.

The first retaining surface 40 is configured to hold the first component 12 and the second component 14 against one another, as will be explained below in further detail.

A region of the second end portion 38 protruding on the first side 34a has a second retaining surface 42. The second retaining surface 42 faces the first end portion 36.

This means that a surface normal of the second retaining surface 42 has a component which points in the direction of the first end portion 36.

The second retaining surface 42 is also configured to hold the first component 12 and the second component 14 against one another, as will be explained below in further detail.

Furthermore, a region of the first end portion 36 protruding on the second side 34b has a third retaining surface 44. The third retaining surface 44 faces the second end portion 38. This means that a surface normal of the third retaining surface 44 has a component which points in the direction of the second end portion 38.

The third retaining surface 44 is configured to hold the first component 12 and the second component 14 against one another, as will be explained below in further detail.

Moreover, a region of the second end portion 38 protruding on the second side 34b has a fourth retaining surface 46. The fourth retaining surface 46 faces the first end portion 36. This means that a surface normal of the fourth retaining surface 46 has a component which points in the direction of the first end portion 36.

The fourth retaining surface 46 is also configured to hold the first component 12 and the second component 14 against one another, as will be explained below in further detail.

In this case, in the depicted embodiment, the first retaining surface 40 and the second retaining surface 42 are in each case inclined overall relative to the central portion axis A in a view perpendicular to the first side 34a. This means that the entire first retaining surface 40 and the entire second retaining surface 42 extend neither parallel nor perpendicular to the central portion axis A.

The first retaining surface 40 and the second retaining surface 42 here extend substantially over the entire width of the connector 32, the width being measured perpendicular to the central portion axis A in a view perpendicular to the first side 34a.

In this case, in the view perpendicular to the first side 34a of the central portion 34, both the first retaining surface 40 and the second retaining surface 42 intersect with the central portion axis A.

In the depicted embodiment, the first retaining surface 40 forms an angle α of approximately 80° with the central portion axis A. The same applies to the second retaining surface 42 and the central portion axis A.

The first retaining surface 40 and the second retaining surface 42 are inclined such that they are parallel. The first retaining surface 40 and the second retaining surface 42 are thus inclined in the same direction.

Likewise, in the depicted embodiment, the third retaining surface 44 and the fourth retaining surface 46 are in each case inclined overall relative to the central portion axis A in a view perpendicular to the second side 34b. This again means that the entire third retaining surface 44 and the entire fourth retaining surface 46 extend neither parallel nor perpendicular to the central portion axis A.

The third retaining surface 44 and the fourth retaining surface 46 here extend substantially over the entire width of the connector 32, the width being measured perpendicular to the central portion axis A in a view perpendicular to the second side 34b.

In this case, in the view perpendicular to the second side 34b of the central portion 34, both the third retaining surface 44 and the fourth retaining surface 46 intersect with the central portion axis A.

In the depicted embodiment, the third retaining surface 44 forms an angle α of approximately 80° with the central portion axis A. The same applies to the fourth retaining surface 46 and the central portion axis A.

The third retaining surface 44 and the fourth retaining surface 46 are inclined such that they are parallel. The third retaining surface 44 and the fourth retaining surface 46 are thus inclined in the same direction.

In this case, the first retaining surface 40 and the third retaining surface 44 lie in a common plane.

Likewise, the second retaining surface 42 and the fourth retaining surface 46 lie in a common plane.

Moreover, in a view along the central portion axis A, the first end portion 36 of the connector 32 according to the fifth embodiment is asymmetric. This is achieved by the first end portion 36 having an edge-side, notch-shaped recess 66.

The same applies to the second end portion 38, i.e., the second end portion 38 is also asymmetric in a view along the central portion axis A. This is achieved by an edge-side, notch-shaped recess 68.

As a result of the recesses 66, 68, the connector 32 can only be inserted into the groove 50 and into the groove 58 in a predetermined orientation, as will be further explained below.

In the component connection 10, the first component 12 and the second component 14 are oriented in such a way that the component side 52 of the first component 12 and the component side 60 of the second component 14 rest against one another.

Furthermore, the groove 50 and the groove 58 are opposite one another at least in part.

In this case, the connector 32 is placed in the groove 50 of the first component 12 in such a way that the first end portion 36 lies in the second groove depth portion 54b.

At the same time, the first retaining surface 40 of the connector 32 comes into contact with the retaining surface 56a of the groove 50 and the third retaining surface 44 of the connector 32 comes into contact with the retaining surface 56b of the groove 50.

Furthermore, the connector 32 is placed in the groove 58 of the second component 14 in such a way that the second end portion 38 lies in the second groove depth portion 62b.

At the same time, the second retaining surface 42 of the connector 32 comes into contact with the retaining surface 64a of the groove 58 and the fourth retaining surface 46 of the connector 32 comes into contact with the retaining surface 64b of the groove 58.

The slant of the first retaining surface 40, the second retaining surface 42, the third retaining surface 44, and the fourth retaining surface 46 here ensures that the first component 12 and the second component 14 rest against one another under tension.

This becomes especially clear if consideration is given to how the component connection 10 is produced, which will be explained below in connection with FIGS. 12 to 14.

In a first step, the first end portion 36 of the connector 32 is inserted into the first groove portion 50a. This takes place along the groove depth direction T. An end-face end of the first end portion 36 comes to rest in the process against a groove base bounding the groove 50 in the groove depth direction T.

Due to the groove 50 being provided with an edge-side projection 70, which corresponds to the edge-side recess 66 in the connector 32, the connector 32 can only be inserted into the first groove portion 50a of the groove 50 in a predetermined orientation. A length of the first groove portion 50a of the groove 50 is additionally matched to a length of the end portion 36 with the edge-side recess 66. The connector 32 cannot therefore be inserted past the projection 70 into the first groove portion 50a.

The connector 32 is then displaced along the groove length direction N into the second groove portion 50b.

In the process, the first retaining surface 40 and the third retaining surface 44 of the connector 32 come into contact with the respectively associated retaining surface 56a, 56b of the groove 50. Due to the slant of the first retaining surface 40 and the third retaining surface 44 of the connector 32, this coming into contact loads the connector in the direction of the groove base of the groove 50.

Then the second end portion 38 is inserted into the first groove portion 58a of the groove 58 in the second component 14. All that is required here is relative motion of the interconnection of first component 12 and connector 32 relative to the second component 14. In this respect it is thus possible for the second component 14 to be laid onto the interconnection of first component 12 and connector 32. Alternatively, it is possible to hold the second component 14 still and move the interconnection of first component 12 and connector 32. Both variants involve insertion of the second end portion 38 into the first groove portion 58a of the groove 58 along the groove depth direction T.

Since the groove 58 is also provided with an edge-side projection 72, which corresponds to the edge-side recess 68 in the connector 32, the connector 32 can only be inserted into the first groove portion 58a of the groove 58 in a predetermined orientation. A length of the first groove portion 50a of the groove 50 is again additionally matched to a length of the end portion 38 with the edge-side recess 68. The connector 32 cannot therefore be inserted past the projection 72 into the first groove portion 58a.

The second end portion 38 is then displaced into the second groove portion 58b. This displacement takes place along groove length direction N. Since the groove 50 and the groove 58 are arranged in such a way in the respectively associated first component 12 or second component 14 that the first groove portion 50a of the groove 50 and the first groove portion 58a of the groove 58 face away from one another, the first component 12 and the second component 14 have to this end to be displaced relative to one another along the groove length direction N. In the process, the slant of the second retaining surface 42 of the connector 32 and the slant of the fourth retaining surface 46 of the connector 32 ensure that the second end portion 38 of the connector 32 is loaded in the direction of a groove base of the groove 58. In other words, the first component 12 and the second component 14 are applied against one another in force-loaded manner.

In a case where the connector 32 has been inserted solely into the groove 50 in the first component 12 or into the groove 58 in the second component 14, the combination of first component 12 or second component 14 and the connector 32 may also be denoted component assembly 48.

FIGS. 16 and 17 show connectors 32 according to a sixth embodiment (FIG. 16) and a seventh embodiment (FIG. 17). Only the differences with regard to the connector 32 according to the fifth embodiment will be addressed below.

In the case of the connector according to the sixth and seventh embodiments, each of the retaining surfaces 40, 42, 44, 46 comprises a total of two surface segments which, though inclined in the same direction, are inclined by different degrees relative to the central portion axis A. In these embodiments, the surface segments with different gradients merge gently together, i.e., by means of a rounded portion.

In the case of the connector according to the seventh embodiment, each of the retaining surfaces 40, 42, 44, 46 is further provided with two elasticity segments E1, E2 which are designated E1 and E2 in the depiction according to FIG. 17. Here, the elasticity segments E1 have greater elastic resilience compared with elasticity segments E2 due to the slot-shaped recesses 50. The increased elastic resilience leads to improved anchoring of the connector 32 in the groove 50 and the groove 58.

FIG. 18 shows a connector 32 according to an eighth embodiment. Each of the retaining surfaces 40, 42, 44, 46 here comprises a plateau portion P which extends perpendicular relative to the central portion axis A.

Along a width direction, the plateau portion P is in this case always arranged on the side of the central part axis A which is located at the rear in the assembly direction.

The plateau portion P and the recess 66, 68 are therefore always arranged on opposing sides of the end portion 36, 38 of the connector 32 relative to the central part axis A.

Such a plateau portion enables maintenance of a contact force level achieved by relative displacement of the first component 12 and the second component 14.

In an alternative not shown in any greater detail, in analogy to the embodiments of FIGS. 16 and 17, plateau portion P can be replaced with a further surface segment which is inclined relative to the central portion axis A. Accordingly, in this variant each of the retaining surfaces 40, 42, 44, 46 has two surface segments inclined by different degrees.

Likewise, each of the connectors of FIGS. 15 to 18 can have a segment at the retaining surfaces 40, 42, 44, 46 which exhibits surface texturing.

In the examples according to FIGS. 12 to 18, retaining surfaces 40, 42, 44, 46 are provided on the connector 32 which extend in inclined manner relative to the central portion axis A. These retaining surfaces 40, 42, 44, 46 may in each case interact with the retaining surfaces 56a, 56b, 64a, 64b of the groove 50 of the first component 12 and the groove 58 of the second component 14 in order to bring about a mechanically stable and reliable component connection 10. In the examples according to FIGS. 12 to 18, the retaining surfaces 56a, 56b, 64a, 64b extend substantially parallel to the component side 52 and to the component side 60.

Alternatively, this mode of action may be kinematically reversed.

This means that the retaining surfaces 40, 42, 44, 46 on the connector 32 may, but need not, continue to extend in inclined manner as explained with reference to FIGS. 12 to 18. In this respect, in a view perpendicular to the first side 34a and in a view perpendicular to the second side 34b, the retaining surfaces 40, 42, 44, 46 of the connector 32 may be oriented perpendicular to the central portion axis A.

In this alternative, the retaining surfaces 56a, 56b are then inclined relative to a groove depth direction T of the groove 50. This is apparent if the first component 12 is viewed along a groove width direction b, B.

In this case, the retaining surfaces 56a, 56b are oriented in such a way that there is a minimal distance between the respective retaining surface 56a, 56b and the component side 52 adjacent to the first groove portion 50a and a maximal distance between the respective retaining surface 56a, 56b and the component side 52 at an end remote from the first groove portion 50a.

The retaining surfaces 64a, 64b are inclined in the same way relative to a groove depth direction T of the groove 58. This is apparent if the second component 14 is viewed along a groove width direction b, B.

This gives rise to a mechanically stable and reliable component connection 10.

It goes without saying that, in this alternative, in accordance with the explanations given for FIGS. 17 to 18, retaining surface segments may be provided which are inclined by different degrees.

It is further possible for the retaining surfaces 56a, 56b, 64a, 64b to have plateau segments. The plateau segments extend parallel to the component side 52, 60. The above explanations in relation to the plateau segments of the connector 32 apply mutatis mutandis in this respect.

The retaining surfaces 56a, 56b, 64a, 64b may also have segments with surface texturing.

FIGS. 19 and 20 show a connector 32 according to a ninth embodiment. Here, the connector 32 according to the ninth embodiment may be considered a variant of the connector according to the fifth embodiment (see FIG. 15). Accordingly, only the differences with regard to the connector 32 according to the fifth embodiment will be addressed below.

A first difference consists in the fact that the retaining surfaces provided on the first end portion 36, i.e., the first retaining surface 40 and the third retaining surface 44, as a whole extend perpendicular to the central portion axis A in a view perpendicular to the first side 34a of the central portion 34 and in a view perpendicular to the second side 34b of the central portion 34. In the ninth embodiment of the connector 32, the first retaining surface 40 and the third retaining surface 44 are thus not inclined relative to the central portion axis A.

In this embodiment, the entire first retaining surface 40 may consequently be considered a plateau portion P which extends substantially over the entire width of the first side 34a.

Likewise, the entire third retaining surface 44 may consequently be considered a plateau portion P which extends substantially over the entire width of the second side 34b.

Similarly to the eighth embodiment according to FIG. 18, the second retaining surface 42 and the fourth retaining surface 46 in each case comprise a plateau portion P which extends perpendicular relative to the central portion axis A. Each of the second retaining surface 42 and fourth retaining surface 46 further comprise a surface segment F1 inclined relative to the central portion axis A.

Moreover, in a view along the central portion axis A, the first end portion 36 of the connector 32 according to the ninth embodiment is asymmetric. This is achieved by the first end portion 36 having an edge-side, notch-shaped recess 66 on both sides.

The same applies to the second end portion 38, i.e., the second end portion 38 is also asymmetric in a view along the central portion axis A. This is achieved by edge-side, notch-shaped recesses 68 provided on both sides.

The connector 32 according to the ninth embodiment is configured to connect a first component 12 and a second component 14 which are in each case equipped with a groove 50, 58, as already explained with reference to FIGS. 12 to 14.

As a result of the recesses 66, 68, the connector 32 can thus be inserted into the groove 50 and into the groove 58 in each case only in a predetermined orientation.

A component connection 10 comprising the connector 32 according to the ninth embodiment is here produced substantially exactly as already explained in respect to FIGS. 12 to 18. However, in the present case, the first end portion 36 is firstly arranged via the first groove portion 50a in the second groove portion 50b of the groove 50 of the first component 12. Then the second end portion 38 is firstly inserted into the first groove portion 58a of the groove 58 in the second component 14. Then the first component 12 and the second component 14 are displaced relative to one another in such a way that the second end portion 38 is moved, with the surface segments F1 of the second retaining surface 42 and the fourth retaining surface 46 to the fore, into the second groove portion 58b of the groove 58.

FIGS. 21 and 22 show a connector 32 according to a tenth embodiment. Here, the connector 32 according to the tenth embodiment may be considered a variant of the connector according to the ninth embodiment (see FIGS. 19 and 20). Accordingly, only the differences with regard to the connector 32 according to the ninth embodiment will be addressed below.

As with all the previously presented connectors 32, the connector 32 according to the tenth embodiment also has an end surface 38a on a side of the second end portion 38 remote from the first end portion 36.

The connector 32 likewise has an end surface 36a on a side of the first end portion 36 remote from the second end portion 38.

The end surface 36a and the end surface 38a thus constitute end surfaces of the connector 32 along the central portion axis A.

In the case of the connector according to the tenth embodiment, the end surface 36a is formed of a leaf spring element 74 which, in a view perpendicular to the first side 34a of the central portion 34 or to the second side 34b of the central portion 34, extends arcuately from one end of the end portion 36 to the other end of the end portion 36.

In this view, the leaf spring element 74 forms a cavity with the other portions of the connector 32. In addition, the leaf spring element 74 is thin compared with the other portions of the connector 32.

Consequently, the leaf spring element 74 may be elastically deformed when force is applied appropriately thereto, reducing the size of the cavity at least along the central portion axis A. In particular, the leaf spring element 74 yields elastically when loaded with a compressive force acting along the central portion axis A in the direction of the central portion 34.

Consequently, in the case of the connector 32 according to the tenth embodiment, the end surface 36a is elastically resilient.

In the present case, the leaf spring element 74 is integral with the other portions of the connector 32.

In a situation where the connector 32 is coupled at least to the first component 12, the leaf spring element 74 may be elastically deformed by contact with a groove base of the groove 50. This elastic deformation results in a contact force by means of which the first retaining surface 40 and the third retaining surface 44 are pressed against the respectively associated retaining surfaces 56a, 56b of the groove 50. This is visible in FIGS. 23 and 24.

It goes without saying that it is also possible, in a variant not shown in any greater detail, to provide an elastically resilient leaf spring element on the second end portion, so making the end surface 38a of the second end portion 38 elastically resilient. In this case, the elastically resilient end surface 38a may be provided as an alternative or in addition to the elastically resilient end surface 36.

FIGS. 25 and 26 show a connector 32 according to an eleventh embodiment. Here, the connector 32 according to the eleventh embodiment may be considered a variant of the connector according to the tenth embodiment (see FIGS. 21 and 22). Accordingly, only the differences with regard to the connector 32 according to the tenth embodiment will be addressed below.

In the case of the connector according to the eleventh embodiment, the second retaining surface 42 and the fourth retaining surface 46 are elastically resilient in part.

To this end, the second end portion 38 comprises a first leaf spring element 76 and a second leaf spring element 78. The first leaf spring element 76 here forms a portion of the second retaining surface 42. Furthermore, the first leaf spring element 76 forms a cavity with the other portions of the second end portion 38.

The second leaf spring element 78 forms a portion of the fourth retaining surface 46. The fourth leaf spring element 78 likewise forms a cavity with the other portions of the second end portion 38.

In this case, although the first leaf spring element 76 and the second leaf spring element 78 are integral with the other portions of the second end portion 38 and the connector 32, they are comparatively thin, such that the first leaf spring element 76 and the second leaf spring element 78 can be elastically deformed by application of an appropriate force and utilization of the freedom of movement provided by the cavities.

A further difference between the connector 32 according to the eleventh embodiment and the connectors already explained is that the central portion 34 has two portions adjoining one another along the central portion axis A, wherein a portion of the central portion 34 adjacent the second end portion 38 is tapered relative to the portion of the central portion 34 adjacent the first end portion 36, i.e., is narrower.

This feature means that a groove 58 in the second component 14 can be narrower, at least in the first depth portion 62a, than at least the first depth portion 54a of the groove 50 in the first component 12. In this case, the connector 32 can only be used to connect the first component 12 and the second component 14 in the predetermined orientation, i.e., with the first end portion 36 in the groove 50 and with the second end portion 38 in the groove 58. This prevents errors when using the connector 32, i.e., mistake-proofs the process.

Alternatively, the taper may also serve merely to provide sufficient structural space for the first leaf spring element 76 and the second leaf spring element 78. In this respect, none of the grooves is made narrower.

In a situation where the connector 32 is coupled at least to the second component 14, the first leaf spring element 76 and the second leaf spring element 58 may be elastically deformed by contact with the respectively associated retaining surface 64a, 64b of the groove 58. This elastic deformation results in a contact force by means of which the second retaining surface 42 and the fourth retaining surface 46 are pressed against the respectively associated retaining surfaces 64a, 64b of the groove 58. This is illustrated in FIGS. 27 and 28.

It goes without saying that it is also possible, in a variant not shown in any greater detail, to provide elastically resilient leaf spring elements on other retaining surfaces, in particular on the first retaining surface 40 and/or the third retaining surface 44, so making the first retaining surface 40 and/or the third retaining surface 44 elastically resilient at least in part.

FIGS. 29 to 31 show a connector 32 according to a twelfth embodiment.

Here, the connector 32 according to the twelfth embodiment may be considered a variant of the connectors 32 already explained, in particular of the connector 32 according to the ninth embodiment (see FIGS. 19 and 20). Accordingly, only the differences with regard to the connectors already explained, in particular with regard to the connector 32 according to the ninth embodiment, will be addressed below.

The connector 32 according to the twelfth embodiment differs from the above-explained connectors in substantially two aspects.

A first aspect relates to a blocking projection 80 for fixing the connector 32 in a groove 50, 58, in the present case in groove 50.

The blocking projection 80 is here embodied as an integral constituent part of the connector 32 which, in a view perpendicular to the first side 34a of the central portion 34 or in a view perpendicular to the second side 34b of the central portion 34, juts out laterally from the central portion 34 and from the first end portion 36.

In the depicted embodiment, the blocking projection 80 is block-shaped.

An outer contour of the blocking projection 80 here corresponds substantially to an inner contour of the first groove portion 50a of the groove 50, i.e., to the groove portion into which it is intended to be received to connect the first component 12 and the second component 14.

As a result of the blocking projection 80, the length of the groove 50 along the groove length direction N here corresponds substantially to the length of the connector along the same direction, when the connector has been inserted into the groove 50.

In a situation where the connector according to the twelfth embodiment has been inserted in the groove 50, it can thus no longer be moved along the groove length direction N due to the blocking projection 80.

A second aspect relates to the fact that, in the case of the connector 32 according to the twelfth embodiment, the first retaining surface 40 and the third retaining surface 44 are mounted so as to be elastically resilient in a direction toward the central portion axis A. The first retaining surface 40 and the third retaining surface may thus be moved by elastic deformation of the central portion 34 toward the central portion axis A.

For this purpose, the first end portion 36 and part of the central portion 34 are hollow (see in particular FIG. 33 and FIG. 35).

In addition, the portion of the first end portion 36 comprising the first retaining surface 40 is separated from the other portions of the first end portion 36 by way of lateral slots 82, 84. The lateral slots 82, 84 here extend as far as into the central portion 34.

Consequently, through elastic flexure of a portion of the central portion 34 located between the slots 82, 84, which portion may also be designated a wall portion due to the hollow embodiment of this region of the central portion 34, the first retaining surface 40 may be moved in the direction of the central portion axis A.

At an opposite end of the first end portion 36 from the retaining surface 40 along the central portion axis A, an insertion bevel 86 is further provided, the function of which will be explained below in greater detail.

Likewise, the portion of the first end portion 36 comprising the third retaining surface 44 is separated from the other portions of the first end portion 36 by way of lateral slots 88, 90. The lateral slots 88, 90 here extend as far as into the central portion 34.

Consequently, through elastic flexure of a portion of the central portion 34 located between the slots 88, 90, which portion may also be designated a wall portion due to the hollow embodiment of this region of the central portion 34, the third retaining surface 44 may be moved in the direction of the central portion axis A.

At an opposite end of the first end portion 36 from the retaining surface 40 along the central portion axis A, an insertion bevel 92 is further provided, the function of which will be explained below in greater detail.

The connector 32 according to the twelfth embodiment can thus be inserted into the groove 50 in the first component 12 along a groove depth direction. In this respect, FIGS. 33 to 35 show the connector in a situation where it has been inserted into the groove 50. In the depiction in FIG. 32, the first component 12 and the connector 32 are depicted separately from one another.

Since the blocking projection 80 is intended to be positioned in the first groove portion 50a and the first end portion 36 in the second groove portion 50b, the connector 32 is firstly positioned above the groove opening in such a way that the blocking projection 80 is located opposite the first groove portion 50a and the first end portion 36 is located opposite the second groove portion 50b.

If the connector 32 is then moved further in groove depth direction T, the insertion bevels 86, 92 come into contact with an edge of the groove opening.

A force by which the connector 32 is pressed into the groove 50 along the groove depth direction T is split by way of the insertion bevels 86, 92 into at least one force component which elastically deforms the portion comprising the first retaining surface 40 in the direction of the central portion axis A, and a force component which elastically deforms the portion comprising the third retaining surface 44 in the direction of the central portion axis A.

In other words, the portion comprising the first retaining surface 40 and the portion comprising the third retaining surface 44 recede elastically in the direction of the central portion axis A, such that the connector 32 can be moved through the first groove depth portion 54a.

In this respect, the blocking projection 80 may, due to its shape and dimensions, move without hindrance along the groove depth direction and into the first groove portion 50a.

As soon as the first end portion 36 reaches the second groove depth portion 54b and the first retaining surface 40 and the third retaining surface 44 lie behind the respectively associated retaining surfaces 56a, 56b of the groove 50 along the groove depth direction, the connector 32 may deform back elastically, such that the first retaining surface 40 and the third retaining surface 44 engage behind the respectively associated retaining surface 56a, 56b.

In other words, the connector 32 may thus be clipped into the groove 50 or latched in the groove 50.

FIG. 36 shows a blocking element 94 which, together with a connector 32, forms a connector assembly 96. The blocking element 94 is thus suitable for a connector assembly 96.

The blocking element 94 is substantially block-shaped, an outer contour of the blocking element 94 corresponding substantially to an inner contour of the first groove portion 50a of the groove 50.

The blocking element 94 may thus be accommodated substantially without play in the first portion 50a of the groove 50 (see also FIGS. 37 to 39).

Furthermore, the blocking element 94 has a bearing region, which is configured to be applied against the connector 32 so as to fix the connector 32 in the groove 50.

The bearing region is here curved slightly outward, i.e., convexly (see in particular FIG. 39). This serves to secure the connector 32 in place in the groove 50 by way of the blocking element 94.

Furthermore, the blocking element 94 comprises a tool interface 100. In the present case, the tool interface 100 takes the form of a blind hole. In addition, the tool interface 100 is configured to cooperate with a tool. This serves to enable the blocking element 94 to be removed again if need be from the groove 50, more precisely from the first groove portion 50a, using the tool.

FIGS. 37 to 39 show a connector assembly 96 comprising the blocking element 94 and the connector 32 according to the ninth embodiment (see also FIGS. 19 and 20).

The connector 32 is here, as already explained, positioned in the second groove portion 50a of the groove 50, i.e., the first end portion 36 and part of the central portion 34 lie within the groove 50.

The blocking element 94 is arranged fully within the first groove portion 50. In this case, the blocking element 94, more precisely the bearing region 98 of the blocking element 94, rests against the connector 32. Due to the convex curvature of the blocking element 94, the blocking element 94 and the connector 32 are secured in place in the groove 50 along the groove length direction N. This involves the connector 32 and the blocking element being accommodated in play-free manner in the groove 50 at least along the groove length direction N.

It is consequently impossible to remove the connector 32 from the groove 50 without first removing the blocking element 94.

The connector assembly 96 may be connected with the second component 14, as already explained in respect to the connector according to the ninth embodiment. At this point, the blocking element 94 has no role to play (see FIG. 39).

### LIST OF REFERENCE SIGNS

10 Component connection
12 First component
12a First surface of first component
12b Second surface of second component
14 Second component
14a First surface of second component
14b Second surface of second component
16 Component edge of first component
18 Recess in first component
18a First portion of recess in first component
18b Second portion of recess in first component
20a Wall surface of recess in first component
20b Wall surface of recess in first component
22a Undercut
22b Undercut
24 Component edge of second component
26 Recess in second component
26a First portion of recess in second component
26b Second portion of recess in second component
28a Wall surface of recess in second component
28b Wall surface of recess in second component
30a Undercut
30b Undercut
32 Connector
34 Central portion of connector
34a First side of central portion
34b Second side of central portion
36 First end portion of connector
36a End surface of first end portion
38 Second end portion of connector
38a End surface of second end portion
40 First retaining surface
42 Second retaining surface
44 Third retaining surface
46 Fourth retaining surface
48 Component assembly
50 Groove in first component
50a First groove portion
50b Second groove portion
52 Component side
54a First groove depth portion
54b Second groove depth portion
56a Retaining surface of groove
56b Retaining surface of groove
58 Groove in second component
58a First groove portion
58b Second groove portion
60 Component side of second component
62a First groove depth portion
62b Second groove depth portion
64a Retaining surface
64b Retaining surface
66 Recess
68 Recess
70 Projection
72 Projection
74 Leaf spring element
76 First leaf spring element
78 Second leaf spring element
80 Blocking projection
82 Lateral slot
84 Lateral slot
86 Insertion bevel
88 Lateral slot
90 Lateral slot
92 Insertion bevel
94 Blocking element
96 Connector assembly
98 Bearing region of blocking element
100 Tool interface of blocking element
α Angle
A Central portion axis
N Groove length direction
b Groove width
B Groove width
T Groove depth direction
E1 Elasticity segment
E2 Elasticity segment
F Joining direction
F1 Surface segment
F2 Surface segment
F3 Surface segment
P Plateau portion

1. A connector for mechanically connecting a first component and a second component, the connector comprising:
central portion,
a first end portion, and
a second end portion,
wherein the central portion extends along a central portion axis (A), and the first end portion is arranged at a first end of the central portion and the second end portion is arranged at a second end of the central portion,
wherein the first end portion and the second end portion protrude on a first side of the central portion relative to the central portion and a protruding region of the first end portion has a first retaining surface which faces the second end portion and is configured to hold the first component and the second component against one another, and a protruding region of the second end portion has a second retaining surface which faces the first end portion and is configured to hold the first component and the second component against one another, and wherein at least one portion of the first retaining surface and/or at least one portion of the second retaining surface is/are inclined relative to the central portion axis (A) in a view perpendicular to the first side of the central portion.

2. The connector as claimed in claim 1, wherein the first end portion and the second end portion in each case protrude on a second side of the central portion, which is opposite the first side, relative to the central portion and a region of the first end portion protruding relative to the second side has a third retaining surface which faces the second end portion and is configured to hold the first component and the second component against one another, and a region of the second end portion protruding relative to the second side has a fourth retaining surface which faces the first end portion and is configured to hold the first component and the second component against one another, and wherein at least one portion of the third retaining surface and/or at least one portion of the fourth retaining surface is/are inclined relative to the central portion axis (A) in a view perpendicular to the second side of the central portion.

3. The connector as claimed in claim 2, wherein the first retaining surface and the third retaining surface lie in a common plane or extend parallel to one another and/or wherein the second retaining surface and the fourth retaining surface lie in a common plane or extend parallel to one another.

4. The connector as claimed in claim 1,
wherein at least one portion of the first retaining surface and at least one portion of the second retaining surface is inclined and the portion of the first retaining surface and the portion of the second retaining surface are inclined in the same or opposing directions and/or
wherein at least one portion of the third retaining surface and at least one portion of the fourth retaining surface is inclined and the portion of the third retaining surface and the portion of the fourth retaining surface are inclined in the same or opposing directions.

5. The connector as claimed in claim 1, wherein, in a view perpendicular to the first side of the central portion or in a view perpendicular to the second side of the central portion, the inclined portion of the first retaining surface and/or the inclined portion of the second retaining surface and/or the inclined portion of the third retaining surface and/or the inclined portion of the fourth retaining surface intersect(s) with the central portion axis (A).

6. The connector as claimed in claim 1, wherein the inclined portion of the first retaining surface and/or the inclined portion of the second retaining surface extend(s) over at least 30% of a width of the first side of the central portion, wherein the width of the first side extends perpendicular to the central portion axis, and/or
wherein the inclined portion of the third retaining surface and/or the inclined portion of the fourth retaining surface extend(s) over at least 30% of a width of the second side of the central portion, wherein the width of the second side extends perpendicular to the central portion axis (A).

7. (canceled)

8. The connector as claimed in claim 1, wherein at least one of the inclined portion of the first retaining surface, the inclined portion of the second retaining surface, the inclined portion of the third retaining surface, and the inclined portion of the fourth retaining surface comprises at least two surface segments (F1, F2, F3) which are differently inclined relative to the central portion axis (A).

9-11. (canceled)

12. The connector as claimed in claim 1, wherein at least one of the first retaining surface, second retaining surface, third retaining surface, and fourth retaining surface is elastically resilient at least in part.

13. (canceled)

14. The connector as claimed in claim 1, wherein, in a view along the central portion axis (A), the first end portion and/or the second end portion is/are asymmetric.

15. The connector as claimed in claim 1, wherein an elastically resilient end surface is provided on a side of the second end portion remote from the first end portion and/or wherein an elastically resilient end surface is provided on a side of the first end portion remote from the second end portion.

16. The connector as claimed in claim 1, wherein at least one of the first retaining surface, second retaining surface, third retaining surface, and fourth retaining surface is mounted in elastically resilient manner in a direction toward the central portion axis (A).

17. The connector as claimed in claim 1, further comprising:
a blocking projection for fixing the connector in place in a groove, wherein, in a view perpendicular to the first side of the central portion or in a view perpendicular to the second side of the central portion, the blocking projection juts out laterally from the central portion and/or from one of the first end portion and second end portion.

18. A connector assembly, comprising:
a connector as claimed in claim 1, and
a blocking element, wherein the blocking element is separate from the connector and is configured to be applied against the connector in order to fix the connector in place in a groove.

19. A blocking element for a connector assembly as claimed in claim 18.

20. A component having a component side, wherein a groove extending along a groove length direction (N) is arranged in the component side and the groove has, along the groove length direction (N), a first groove portion, which has a constant groove width (B) along a groove depth direction (T), and a second groove portion which adjoins the first groove portion,
wherein, adjacent the component side, the second groove portion has a first groove depth portion with a groove width (b) which is reduced relative to the first groove portion and a second groove depth portion which adjoins the first groove depth portion on a side remote from the component side and has the same groove width (B) as the first groove portion,
wherein, adjacent a side of the first groove depth portion remote from the component side, a retaining surface which forms an undercut effective contrary to the groove depth direction (T) is formed on at least one side of the first groove depth portion,
wherein the retaining surface is inclined relative to the groove depth direction (T).

21. The component as claimed in claim 20, wherein, adjacent the side of the first groove depth portion remote from the component side on both sides along a direction parallel to the groove width (b, B), a retaining surface which forms an undercut effective contrary to the groove depth direction (T) is formed in each case on the first groove depth portion,
wherein both retaining surfaces are inclined relative to the groove depth direction (T).

22. The component as claimed in claim 20, wherein at least one retaining surface comprises at least two retaining surface segments which are differently inclined relative to the groove depth direction (T).

23-25. (canceled)

26. A component assembly, comprising:
a component, and
a connector,
wherein the component is a component as claimed in claim 20, and/or wherein the connector is a connector comprising:
a central portion.
a first end portion, and
a second end portion.
wherein the central portion extends along a central portion axis (A), and the first end portion is arranged at a first end of the central portion and the second end portion is arranged at a second end of the central portion,
wherein the first end portion and the second end portion protrude on a first side of the central portion relative to the central portion and a protruding region of the first end portion has a first retaining surface which faces the second end portion and is configured to hold the first component and the second component against one another, and a protruding region of the second end portion has a second retaining surface which faces the first end portion and is configured to hold the first component and the second component against one another, and
wherein at least one portion of the first retaining surface and/or at least one portion of the second retaining surface is/are inclined relative to the central portion axis (A) in a view perpendicular to the first side of the central portion.

27. A component connection, comprising:
a first component,
a second component, and
a connector, wherein the first component and/or the second component is/are components as claimed in claim 20, and/or
wherein the connector is a connector comprising:
a central portion,
a first end portion, and
a second end portion.
wherein the central portion extends along a central portion axis (A), and the first end portion is arranged at a first end of the central portion and the second end portion is arranged at a second end of the central portion,
wherein the first end portion and the second end portion protrude on a first side of the central portion relative to the central portion and a protruding region of the first end portion has a first retaining surface which faces the second end portion and is configured to hold the first component and the second component against one another, and a protruding region of the second end portion has a second retaining surface which faces the first end portion and is configured to hold the first component and the second component against one another, and
wherein at least one portion of the first retaining surface and/or at least one portion of the second retaining surface is/are inclined relative to the central portion axis (A) in a view perpendicular to the first side of the central portion.

28. A method, comprising:
connecting a first component and a second component with a connector as claimed in claim 1.
